(19) United States
(12) Patent Application Publication
(10) Pub. No.: US 2022/0398273 A1
(43) Pub. Date: Dec. 15, 2022

(54) SOFTWARE-AIDED CONSISTENT ANALYSIS OF DOCUMENTS

(71) Applicant: UnitedLex Corp., Overland Park, KS (US)

(72) Inventors: Joseph F. Dearing, Chapel Hill, NC (US); Anand Prakash Rohit, Stittsville (CA); Sean Daniel Jennings, Potomac, MD (US); Joao Pedro Cardoso Canhenha, Marietta, GA (US); Michelle C. Kish, Raleigh, NC (US)

(21) Appl. No.: 17/836,750

(22) Filed: Jun. 9, 2022

Related U.S. Application Data
(60) Provisional application No. 63/209,568, filed on Jun. 11, 2021.

(51) Int. Cl. G06F 16/35; G06F 16/338; G06F 40/205

(52) U.S. Cl. CPC G06F 16/353; G06F 16/338; G06F 40/205; G06N 3/10

(57) ABSTRACT

The present technology pertains to a system for automatic analysis and segregation of documents. The system provides a graphical user interface for receiving inputs pertaining to a first document of a plurality of documents in a document analysis project. For example, the graphical user interfaces may receive a classification input classifying the first document with a first classification. The system automatically analyzes other documents in the plurality of documents to identify a subset of documents that are similar to the first document, and automatically classify the subset of the documents that are similar to the first document with the first classification. Further, the present technology pertains to conducting a patent analysis project by a team of analysts, including presenting a detailed analysis user interface for reviewing patent-related documents, where the detailed analysis user interface includes text of a first patent-related document to be analyzed and categories and related subcategories.

### CROSS-REFERENCE TO RELATED APPLICATIONS

This application claims priority to U.S. Provisional Application No. 63/209,568 filed on Jun. 11, 2021 titled “SOFTWARE AIDED CONSISTENT ANALYSIS OF DOCUMENTS” and expressly incorporates the contents thereof in its entirety.

### BACKGROUND

A patent analyst, for a single analysis assignment or a project, may have to scan through multiple patent-related documents to complete the analysis. The patent analyst may be required to read through each of the multiple patent-related documents to determine a set of patent-related documents of a similar classification, which could be a time-consuming process and prone to errors. Further, for a single analysis assignment or a project that includes multiple patent-related documents, a team of patent analysts would be required to complete the project. Each patent analyst on the team of patent analysts would be working on the same project in parallel. The analyst may be required to group the patent-related documents based on categories and multiple subcategories. The team of patent analysts may not be exposed to the findings of each patent analyst while working on the patent-related documents. There could be errors in determining the categories or the subcategories or relevancy for some of the patent-related documents by an analyst due to the lack of exposure. Further, each of the analysts may be required to access different websites to read or review the text corresponding to each of the patent-related documents resulting in a lower productivity.

In certain scenarios, one or more patents might have been already classified in a previously executed projects, and not everyone on the team might be aware of the same, which may amount to rework. Further, the patent analysts working on the current project may classify the one or more patents in a different way that creates discrepancies and lack in uniformity.

### SUMMARY

According to at least one example, the present technology includes a document analysis system and a method for presenting a graphical user interface for receiving inputs pertaining to a first document of a plurality of documents in a document analysis project. The graphical user interface may further receive a classification input classifying the first document with a first classification. Based on the first classification, the document analysis system may automatically analyze other documents in the plurality of documents to identify a subset of documents that are similar to the first document, and automatically classify the subset of the documents that are similar to the first document with the first classification.

The document analysis system is further configured for conducting a patent analysis project by a team of analysts. The document analysis system may present a detailed analysis user interface for reviewing patent-related documents in the patent analysis project, where the detailed analysis user interface includes the text of a first patent-related document to be analyzed as part of the patent analysis project, and categories and related subcategories presented in a first interface portion.

### BRIEF DESCRIPTION OF THE DRAWINGS

FIG. 1 illustrates a document analysis system for consistent analysis of documents, according to an example of the present disclosure.

FIG. 2 illustrates a dashboard interface for presenting an overall view of one or more projects and one or more recent ingestions, according to an example of the present disclosure.

FIG. 3 illustrates a detailed projects interface for providing details of the one or more projects that correspond with a user, according to an example of the present disclosure.

FIG. 4 illustrates a project data interface that displays information associated with the selected project from a list of one or more projects, according to an example of the present disclosure.

FIG. 5 illustrates a patent data interface that displays information related to one or more patents of the project, according to an example of the present disclosure.

FIG. 6 illustrates a document upload interface that receives a data file with a plurality of documents, according to an example of the present disclosure.

FIG. 7 illustrates a field data interface with a list of fields related to the first document, according to an example of the present disclosure.

FIG. 8 illustrates a taxonomy data import user interface that renders one or more documents corresponding to taxonomy associated with the project to the document analysis system, according to an example of the present disclosure.

FIG. 9 illustrates a taxonomy data file that includes a taxonomy list, according to an example of the present disclosure.

FIG. 10 illustrates a taxonomy modification interface for receiving modifications to the categories and corresponding subcategories, according to an example of the present disclosure.

FIG. 11 illustrates a detailed analysis user interface for reviewing all patent-related documents, according to an example of the present disclosure.

FIG. 12 illustrates a keyword input interface for receiving one or more keywords, according to an example of the present disclosure.

FIG. 13 illustrates the detailed analysis user interface with a second interface portion that displays the received one or more keywords, according to an example of the present disclosure.

FIG. 14 illustrates an ingestion information interface, according to an example of the present disclosure.

FIG. 15 illustrates an ingestion report interface, according to an example of the present disclosure.

FIG. 16 illustrates a patent query interface for receiving one or more patent queries, according to an example of the present disclosure.

FIG. 17 illustrates a report interface, according to an example of the present disclosure.

FIG. 18 illustrates a method for automatically categorizing a document in a document analysis project, according to an example of the present disclosure.

FIGS. 19A-19B illustrate a method for conducting a patent analysis project, according to an example of the present disclosure.

FIG. 20 illustrates an example system for carrying out various aspects of the present technology.

### DETAILED DESCRIPTION

A patent analysis assignment or project requires a patent analyst to analyze multiple patent-related documents by reading through and determining a set of patent-related documents that are of a similar classification. However, this analysis is time-consuming and is prone to errors and inconsistencies. Therefore, there exists a need for a technology that may reduce errors in these projects and provide improved consistency across a team of analysts.

The present technology may improve consistency by automatically categorizing a document in a documents analysis project. For example, the present technology may automatically apply a relevant classification to all similar documents, such as similar documents in a patent family, so that all the similar documents are identically classified. This automatic application also provides an efficiency benefit.

The present technology may reduce errors in the patent analysis projects by providing greater transparency and information flow amongst the analysts. The patent analysis project may require a team of patent analysts to analyze multiple patent-related documents by reading through and grouping a set of patent-related documents based on categories and multiple subcategories. Each analyst might view some categories differently than other analysts or might add categories to the project after the project is underway. The team of patent analysts may encounter issues related to transparency corresponding to the findings of each patent analyst while working on the patent-related documents. The variations in the analysis between the analysts may cause errors in determining the categories or the subcategories for some of the patent-related documents. The present technology alleviates these problems in the art by providing one or more interfaces for reviewing and analyzing all patent-related documents in the patent analysis assignment or project that could be provided to the team of analysts, where each analyst may view the findings or the comments of other analysts. Additionally, the present technology may inform about a category added by an analyst in during execution of the project to other analysts or may provide notes pertaining to an evolving description of a category.

The present technology also supports ingestion of analysis data of previously executed projects, also referred to as legacy data. The utilization of the analysis data provides a view of categories and subcategories, ratings, comments, and the like, of one or more patents documents of the previously executed projects. The patent analysts may avoid rework in projects with same or similar one or more patents that were analyzed in the previously executed projects by considering the legacy data. These features improve information flow across the team and also improves the consistency with minimal rework and uniformity.

The present technology includes a document analysis system and corresponding methods that implement the above-mentioned features. The document analysis system and a corresponding method automatically categorizes a document based on a classification input that classifies a first document with a first classification. The document analysis system and the corresponding methods may automatically analyze other documents from the plurality of documents to identify a subset of documents that are similar to the first document, and automatically classify the subset of the documents that are similar to the first document with the first classification.

Further, the document analysis system and the corresponding method provides one or more interfaces to the team of analysts for reviewing and analyzing all patent-related documents in the patent analysis assignment or project. The document analysis system and the method may provide each analyst of the team of analysts an ability to view the findings or the comments of each of the other analysts of the team of analysts. The document analysis system may customize the one or more interfaces to provide an overview of projects, a list of projects, and the like, corresponding to the user or a persona chosen by or associated to the user. The customizations of the one or more user interfaces provide a comprehensive view of the projects and at least associated statuses and deadlines allowing the user to prioritize execution of the projects accordingly. Further, the one or more interfaces display the categories and corresponding sub-categories which allows the user to review relationship of the categories and corresponding sub-categories with each of patent-related documents of the project.

Also, the one or more interfaces allow the user to flag a patent-related document or comment on the patent-related document if the user is, for example, unsure of relevant categories, or believes the patent-related document requires a review from other users or other team members, and the like. The flagging serves as a pointer to the specific patent-related document and additions of comments may provide a context for flagging that reduces the necessity to surf through multiple documents to identify the specific patent-related document. The provision of allowing relevant team members to review or view analyses of other team members results in transparency and information flow amongst the team. The provision supports the team to reach consensus regarding the analyses of the team members and spot issues with the analyses prior to reporting the project analyses to one or more clients.

In an embodiment, an interface of the one or more interfaces may include an amalgamation of data that provides or displays information necessary for analyzing or reviewing the patent-related document. The interface may include a display of text associated with the patent-related document and the categories and sub-categories that could be manually selected for associating the selected categories and sub-categories to the patent-related document. The interface may also include an indication of the categories or the sub-categories applicable or associated to the patent-related document based on the analysis result of the legacy data document. The interface thus provides most of the information necessary to perform an analysis of the patent-related document in a single view, thereby avoiding the necessity to switch views or screens for performing the analysis or storing and viewing multiple documents that could be counterproductive for the user.

In certain scenarios, the team members or patent analysts would have classified one or more patent-related documents in previously executed projects and the one or more patent-related documents of such projects may be present in a current project. A different set of patent analysts, who may not be aware of the previously performed analysis, may be required to work on these one or more patents, which amounts to rework. Further, the patent analysts working on the current project may classify the one or more patents in a different way that creates discrepancies and lack in uniformity. In another scenario, the patent analysts working on the current project may be same as the ones who worked on the one or more patents of the previously executed projects. However, with a substantial time gap between execution of the current and the previously executed project(s), the patent analysts may fail to remember regarding the classifications assigned and related analysis for the previously executed project(s), therefore, leading to rework.

The present technology allows users or patent analysts to search of projects that may include one or more specific patent-related documents. The one or more interfaces may display information regarding the one or more projects associated to the one or more specific patent-related documents. The interface displaying the information regarding the one or more projects provides a clarity to the user, currently working on the one or more specific patent-related documents, regarding previously executed projects and also refer analysis results. The system supports the reusability of analyses results and minimizing rework. Further, with the ingestion of the legacy data document, the system supports the user, with no involvement in the analysis of the previously executed projects, to access, refer, and utilize the corresponding analyses results for executing the current project.

Further, if a team member quits a project midway then another team member can resume the execution of the project with the use of the stored analysis results or comments that are associated to the project. Also, if the team member prefers to put the project on hold and resume after a period, the user may refer to the stored analysis results or comments that are associated to the project without investing excess time to understand the status or information corresponding to the project. Therefore, the present technology allows the user or the team member to resume the execution of the project with minimal disruption in the above-mentioned exigency scenarios.

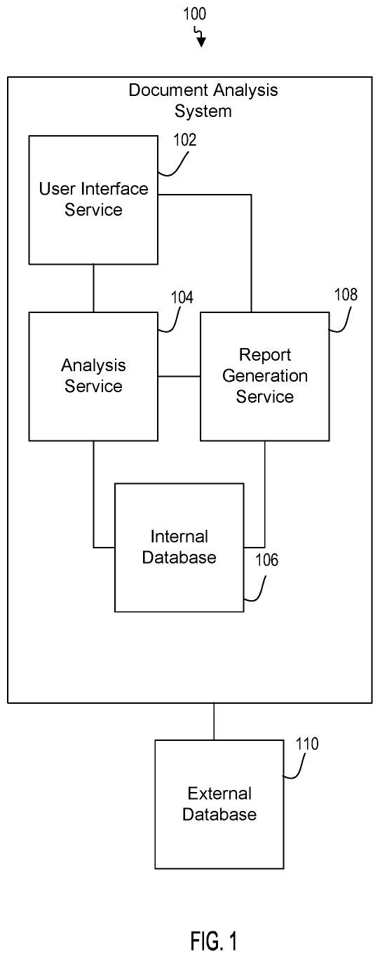

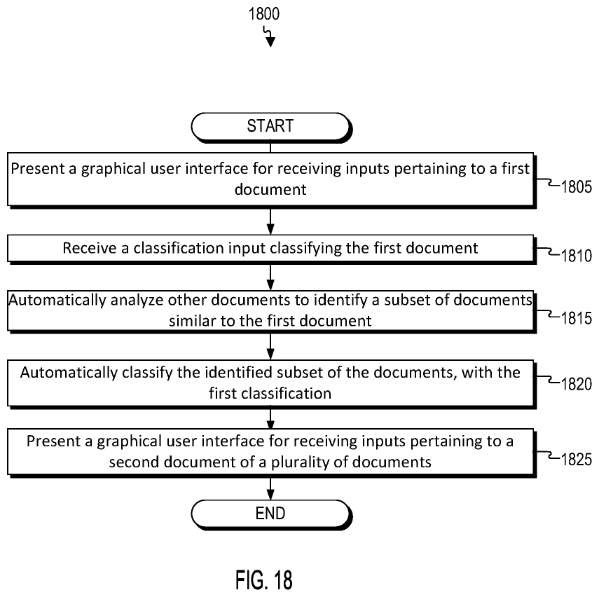

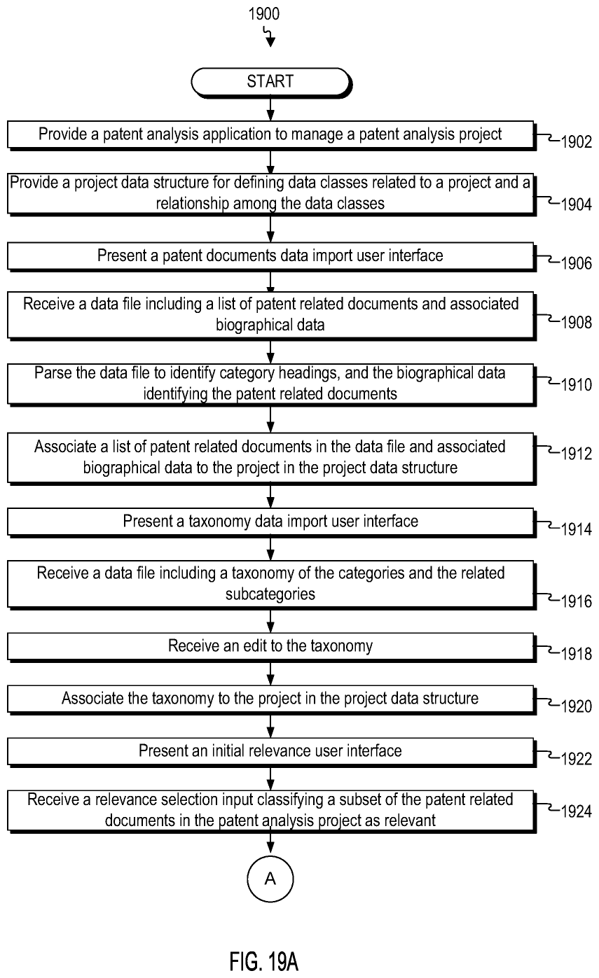

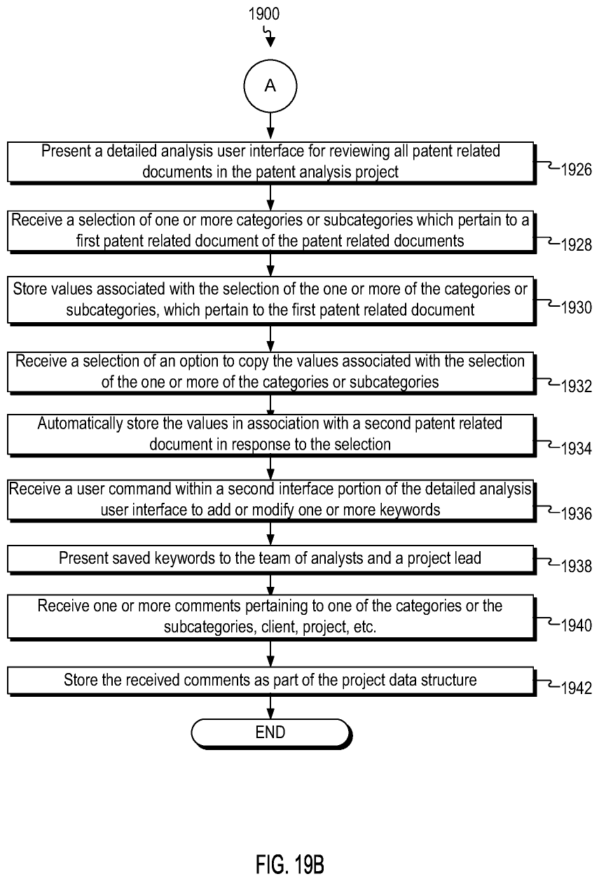

FIG. 1 illustrates a document analysis system 100. The document analysis system 100 includes at least a user interface service 102, an analysis service 104, an internal database 106, and a report generation service 108. The user interface service 102, the analysis service 104, and the report generation service 108 may include one or more processors and one or more memory elements for executing instructions and/or performing steps corresponding to methods or processes later described in FIG. 18 and FIGS. 19A-19B. The memory elements, such as the internal database 106 and an external database 110, are configured to store data, such as virtual content data, one or more images, and the like. The memory elements are coupled to the one or more processors that may be, for example, implemented in circuitry, and configured to execute instructions.

The user interface service 102, the analysis service 104, the report generation service 108, and the internal database 106 of the document analysis system 100 may be present in a single system, such as in a single workstation, or may be distributed across different systems, for example, different workstations, and may be coupled through a wired or a wireless network. The external database 110 is coupled to the document analysis system 100 through the wired or the wireless network.

In some embodiments, the document analysis system 100 determines a subset of documents from a plurality of documents, which are similar to a primary or a first document. The user interface service 102, the analysis service 104, and at least one of the internal database 106 and the external database 110 support the process of determination of the subset of documents from the plurality of documents as discussed later in FIG. 18 and FIGS. 19A and 19B. The plurality of documents may be provided to the document analysis system 100 from an external database 110 that is accessible through a local area network or is in a cloud environment. The external database 110 may be accessed through a wired or a wireless connection.

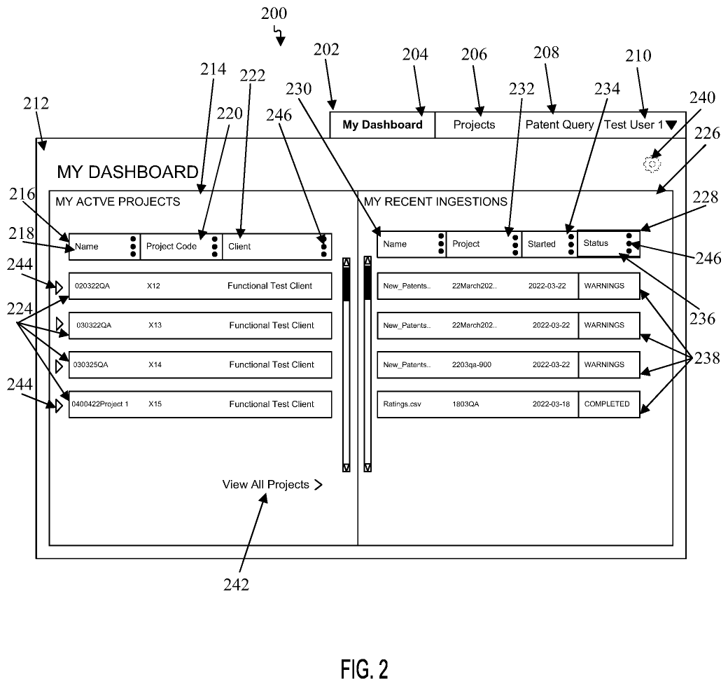

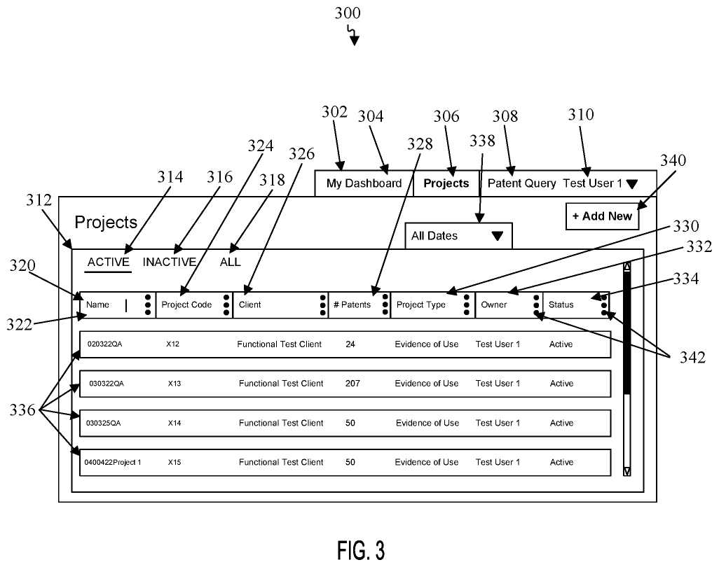

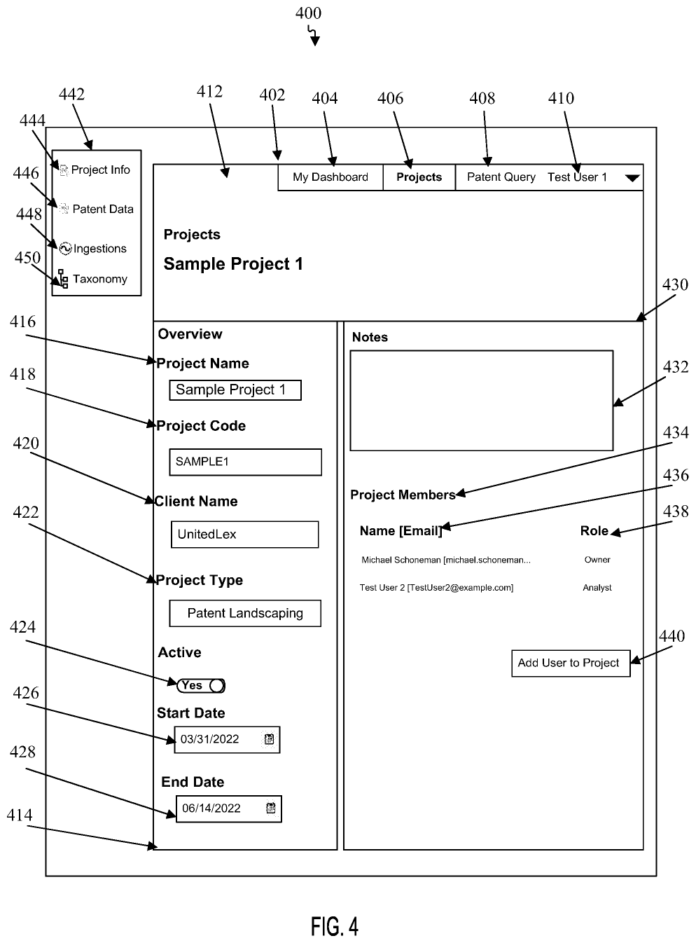

The user interface service 102 may provide various interfaces that display information and support interaction of the user with the displayed information for executing one or more analysis projects, such as the document analysis project or the patent analysis project. For example, the user interface service 102 may present a dashboard interface 200 as disclosed in FIG. 2, a detailed projects interface 300 as disclosed in FIG. 3, a project data interface 400 as disclosed in FIG. 4, and the like.

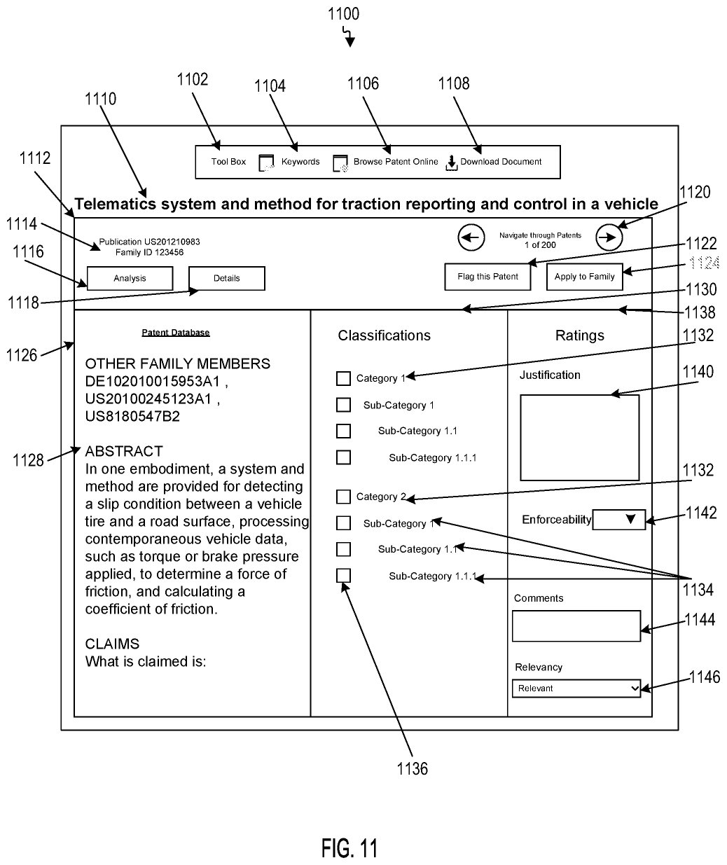

Further, the user interface service 102 also provides a graphical user interface, such as a detailed analysis user interface 1100 later illustrated in FIG. 11, for receiving inputs pertaining to the first document from the plurality of documents in a document analysis project. The plurality of documents are patent-related documents, which include one or more granted patents, published patent applications, or unpublished patent applications. The unpublished applications, in an example, are provisional patent applications, a patent application associated with a non-publication request filed with a patent office of any jurisdiction, a patent application that is yet to be published, and the like. Within the context of the disclosure, the first document corresponds to the patent-related document. Hence, the “first patent-related document” and the “first document” are used interchangeably within the disclosure. However, it will be apparent to one skilled in the art that the first document can be any document, such as a conference paper, a scientific journal, and the like. In an example, the plurality of documents may be documents that were analyzed in a previously executed project.

Further, the user interface service 102 may present a graphical user interface, such as the detailed analysis user interface 1100, later illustrated in FIG. 11, for receiving inputs pertaining to one or more subsequent documents after the first document of the plurality of documents, in the document analysis project. For example, the subsequent document is a second document disclosed in the detailed description of FIG. 11. Within the context of the disclosure, the second document corresponds to the patent-related document. Hence, the “second patent-related document” and the “second document” are used interchangeably within the disclosure. However, it will be apparent to one skilled in the art that the second document can be any document, such as a conference paper, a scientific journal, and the like. The subsequent documents are among the subset of documents that are similar to the first document. The graphical user interface receives inputs pertaining to the subsequent documents automatically including a first classification.

The analysis service 104 automatically analyzes other documents in the plurality of documents to identify a subset of documents that are similar to the first document. In some embodiments, the analysis service 104 determines that a subset of documents is similar when the documents in the subset share a common family attribute which includes a common priority application. In some embodiments, the analysis service 104 determines a subset of documents are similar when they share a textual similarity. In some embodiments, one or more documents that have a common family attribute might not have a sufficient textual similarity to be considered similar. Therefore, if the textual similarity of at least one document from the subset of documents, is not sufficiently similar to the first document, then the analysis service 104 excludes the at least one document from being classified with the first classification. The analysis service 104 automatically classifies the subset of the documents that are similar to the first document with the first classification.

In some embodiments, the analysis service 104 may apply a machine learning algorithm to the plurality of documents to identify the subset of documents that are similar to the first document. The analysis service 104 parses the plurality of documents with a natural language processing algorithm. The natural language processing algorithm, for example, may be one or a combination of: Rapid Automatic Keyword Extraction (RAKE), Doc2Vec, Part-of-speech tagger, Named-entity recognition, and the like.

An output of the natural language processing is provided to a neural network of the analysis service 104 for creating representations of the plurality of documents. The analysis service 104 clusters the representations in an embedding space and the representations of the documents that are most proximate to a representation of the first document are the subset of the documents that are similar to the first document.

In some embodiments, the analysis service 104 may utilize one or more documents that were previously analyzed. The one or more previously analyzed documents include analysis data such as classifications, ratings, and the like, which are extracted by the analysis service 104. Based on the extracted analysis data, the analysis service 104 may automatically classify current documents of the document analysis project which are similar to the one or more previously analyzed documents. Further, the analysis service 104 determines a subset of the documents that are similar to the document that is classified or categorized based on the one or more previously analyzed documents. The utilization of the analysis data of the one or more previously analyzed or executed documents avoids rework.

In some embodiments, the document analysis system 100 may be configured to manage a patent analysis project. The document analysis system 100 may provide a plurality of user interfaces, specifically rendered by the user interface service 102, effective to define a project, a team, patent-related documents to be analyzed, criteria against which to analyze the patent-related document, and interfaces to facilitate such analysis. The user interface service 102, the internal database 106, and the analysis service 104 supports the management of the patent analysis project as discussed in FIGS. 19A and 19B. The patent-related documents may be provided to the document analysis system 100 from the external database 110 that may be accessible through a local area network or may be located in a cloud environment.

The document analysis system 100 further includes a report generation service 108 for providing a report based on the analysis by the analysis service 104. The report generation service 108 receives, as an input, the output from the analysis service 104. The input includes results or data corresponding to the analysis of the patent-related documents. Upon receiving the input, the report generation service 108 generates a report in a default template. The report generation service 108 may also generate one or more visualizations that represent the results of the analysis from the analysis service 104 within the generated report. The report generation service 108 utilizes a default visualization template for representing the analysis. Alternatively, the report generation service 108 may provide a choice of visualization templates and visualization categories for allowing customization of the report.

Further, the report generation service 108 may provide one or more text boxes in the report that allows a user to enter text corresponding to the visualizations. In an embodiment, the one or more text boxes may include automatically populated content based on the received analysis and are editable to support customization of the report. The report generation service 108 provides one or more report templates with similar or different visualization templates and text box options to support customization. The reports may be in an editable format, such as a spreadsheet or a non-editable format, such as, a portable document format (PDF). The report generation service 108 may generate customized reports related to different applications that are supported by the document analysis system 100.

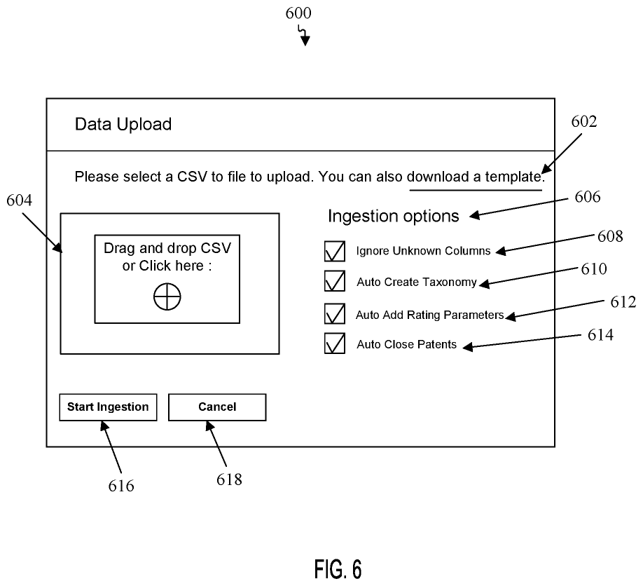

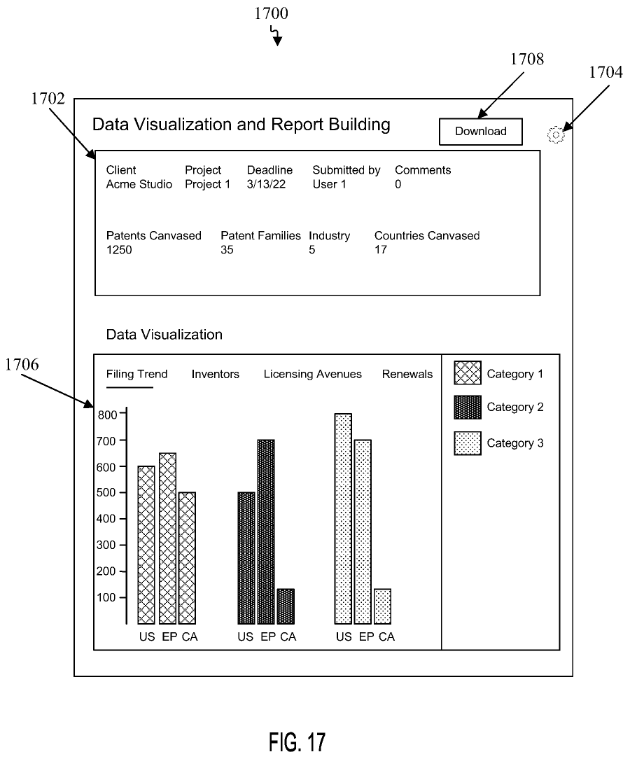

In an embodiment, the document analysis system 100 receives at least a document, such as a data file, with a list of granted patents, published patent applications, or unpublished patent applications and corresponding biographical data through a user interface such as a document upload interface 600, later illustrated in FIG. 6. The data file includes the biographical data such as a Cooperative Patent Classification (CPC) code, a patent number, a publication number, an application number, a title, abstract details, and the like. The analysis service 104 may analyze and group the granted patents, published patent applications, and/or unpublished patent applications of the list based on the CPC code. The report generation service 108 receives the analysis results and the groupings as an input and provides one or more visualizations in a report interface 1700, later illustrated in FIG. 17.

The visualizations may include filing trends, inventors, and the like, with respect to the categories and the subcategories. In an example, the visualization may also show at least a class, one or more subclasses, one or more main groups, one or more subgroups, and the like, corresponding to the CPC code. The visualizations may initially display a class and upon receiving a user input, one or more subclasses may be displayed. Similarly, upon receiving a user input, one or more main groups, corresponding to the subclass, may be displayed. In another example, the visualizations may display the class, one or more subclasses, one or more main groups, one or more subgroups of the CPC code, simultaneously, thereby providing an overview of the received list of the patent-related documents. The document analysis system 100 may support a variety of applications such as patent landscaping, patent renewal or lapse, patent-to-product mapping, portfolio mining or rating, prior art search, target scouting, evidence of use analysis, patent valuation, licensing and sale support, and the like.

The internal database 106 or the external database 110 is communicatively coupled to other services, such as the user interface service 102, the analysis service 104, and the like, of the document analysis system 100, also referred as “system 100” hereafter. The internal database 106 or the external database 110 stores data received from the one or more interfaces rendered by the user interface service 102 and also allows the data to be retrieved for populating the one or more interfaces. The analysis service 104 may perform analysis to the data stored and stores analysis data in the internal database 106 or the external database 110. The report generation service 108 extracts the stored data and templates from the internal database 106 or the external database 110, and stores generated reports. For example, the internal database 106 or the external database 110 receives, through the graphical user interface, such as the detailed analysis user interface 1100, a classification input classifying the first document with the first classification.

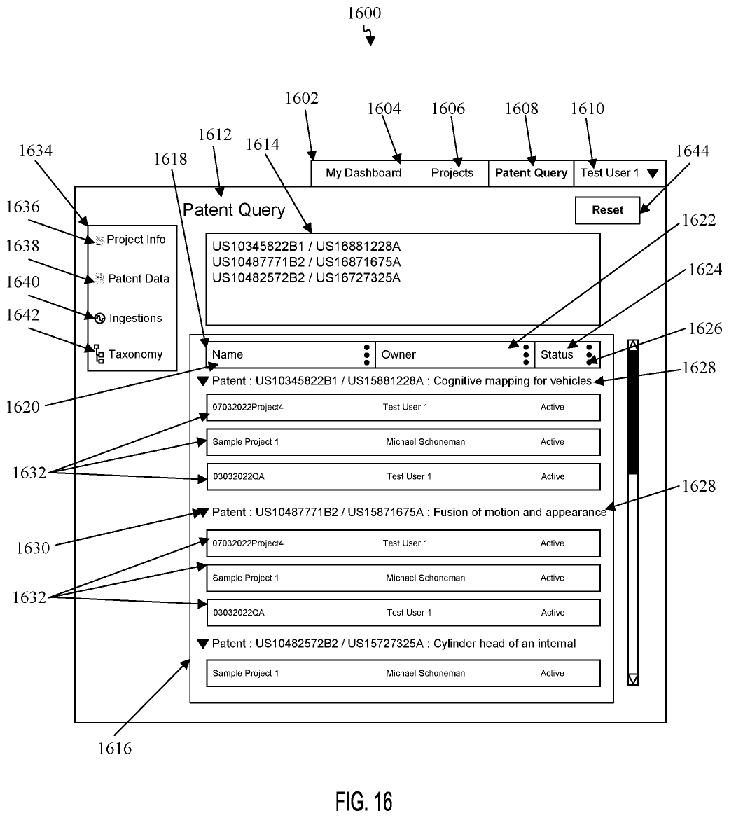

FIG. 2 illustrates the dashboard interface 200 for presenting an overall view of the one or more projects and one or more recent ingestions. The user interface service 102, as illustrated in FIG. 1, provides the dashboard interface 200 after a successful login of a user. The dashboard interface 200 includes an interface bar 202 with a dashboard link 204, a projects link 206, a patent query link 208, and a username information portion 210. When the system 100, as illustrated in FIG. 1, receives an interactive input, such as a click on the dashboard link 204, the system 100 renders the dashboard interface 200. Similarly, when the system 100 receives an interactive input on the projects link 206 and the patent query link 208, the system 100 provides the detailed projects interface 300 (later illustrated in FIG. 3) and a patent query interface 1600 (later illustrated in FIG. 16).

After receiving an interactive input to the username information portion 210, the system 100 displays an identifier (ID) of the user that has logged in and also allows the user to change the persona that corresponds to the user. The change in persona alters the contents or interfaces displayed on the dashboard interface 200. Each persona of the user may be related to a unique set of rights and permissions on the system 100 or on the interfaces provided by the user interface service 102. Based on the change or selection of persona received from the user, the system 100 modifies at least content or aesthetics of the interfaces. The rights and permissions may be associated with reading, writing, modifying, and the like, the contents of the interfaces.

The dashboard interface 200 includes a main portion 212 with widgets such as an active projects interface 214 and a recent ingestions interface 226. The active projects interface 214 displays one or more projects that are currently active. The projects may be document analysis projects or patent analysis projects.

The active projects interface 214 displays a header row 216 with multiple columns and each column displays information headings. The columns include information headings such as a project name 218, a project code 220, and a client name 222. The active projects interface 214 also displays a list of projects 224, which are rows under the header row 216, and each row displays information about a single project in the list of projects 224. Each row includes information such as a project name, a project code and a client name, corresponding to the project, under the information headings such as the project name 218, the project code 220, and the client name 222, respectively.

The project name may be specific to an organization that undertakes the respective analysis projects or may be client specific. In an embodiment, the project code includes a cost center identifying information or other identifying information associated with the project for accounting or organizational purposes. The information under the information headings may be sorted and filtered based on one or more preferences of the user by interacting with corresponding ellipsis components 246.

Further, the system 100 may render an expansion area (not shown) with additional details corresponding to a project, in the list of projects 224, upon receiving an interactive input to an expansion element 244 positioned, such as, beside each row of the list of projects 224. In an embodiment, the displayed information of each project in respective rows include hyperlinks to the project data interface 400, later illustrated in FIG. 4. When a selection on the hyperlink of a project is received, the system 100 provides information regarding the selected project in the project data interface 400.

The recent ingestions interface 226 displays recent ingestions related to at least one of the patent analysis projects and the document analysis projects. The recent ingestions interface 226 displays a header row 228 with multiple columns and each column displays information headings. The columns include information headings such as a name of file ingested 230, a name of a corresponding project 232, a start date of ingestion 234, and a status 236.

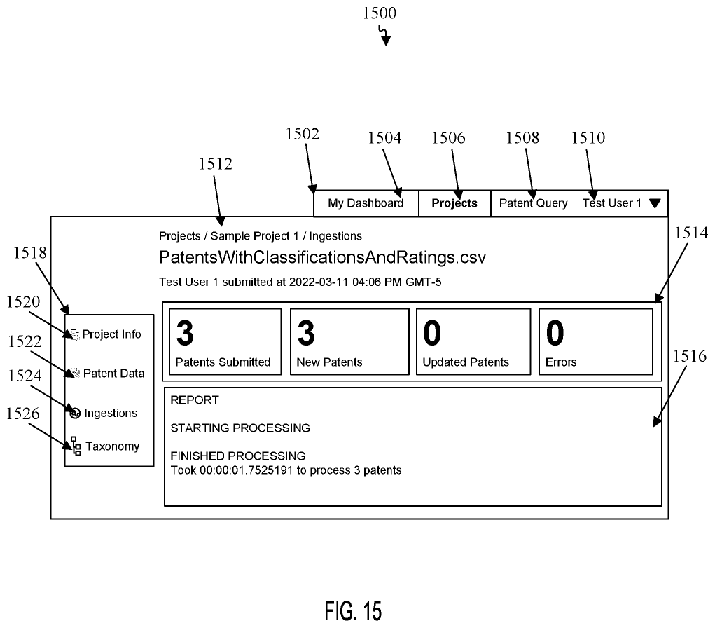

The recent ingestions interface 226 displays a list of recent ingestion documents 238, which are rows under the header row 228, and each row displays information of an ingestion. Each row includes information such as a name of file or document ingested, a name of a corresponding project, a start date of ingestion, and a status. The information of each row is positioned under the corresponding information headings such as the name of file ingested 230, the name of a corresponding project 232, the start date of ingestion 234, and the status 236, respectively. In an embodiment, the displayed information of each ingestion in respective rows include hyperlinks to an ingestion report interface 1500, later illustrated in FIG. 15. When a selection on the hyperlink of an ingestion is received, the system 100 provides information regarding selected ingestion document in the ingestion report interface 1500.

The information under the status information heading 236 indicates a current ingestion status of a document that has been rendered for ingestion. The status information heading 236 may include a submitted status which indicates that a patent file or a document has been submitted for ingestion, but the ingestion has not yet begun. The status information heading 236 may include an in-progress status which indicates that a patent file or a document is currently being ingested. Further, the status information heading 236 may include a warning status which indicates that a patent file or a document has been ingested but there were some components in the file that were not ingested properly. Also, the status information heading 236 may include a failed status which indicates the that no patents, classifications, or ratings have been ingested due to fatal errors in a patent file or a document, Further, the status information heading 236 may include a completed status which indicates that a patent file or a document has been ingested successfully and there may be some unrecognized columns that were ignored.

The dashboard interface 200 further includes a widget icon 240 for rearranging the widgets such as the active projects interface 214 and the recent ingestions interface 226. In an embodiment, the widget icon 240 allows the user to choose a new widget to be displayed on the dashboard interface 200. The new widgets, in an example, include a pending assignments interface (not shown) for displaying list of projects that are yet to be assigned to a team or a flagged patents interface (not shown) for displaying a list of patents that are flagged by team members or by self. In an embodiment, the widget icon 240 allows the user to delete an existing widget from the dashboard interface 200. The dashboard interface 200 also includes a projects viewing link 242, that directs the user to the detailed projects interface 300 when the system 100 receives an interactive input from the user.

FIG. 3 illustrates the detailed projects interface 300 for providing details of the one or more projects that correspond to the user. After detecting an interaction on the projects viewing link 242 or the projects link 206, as illustrated in FIG. 2, the detailed projects interface 300 is provided by the user interface service 102. The detailed projects interface 300 includes an interface bar 302 with links and corresponding functionality similar to the interface bar 202. A dashboard link 304, a projects link 306, a patent query link 308, and a username information portion 310 have a functionality similar to the dashboard link 204, the projects link 206, the patent query link 208, and the username information portion 210, respectively, as illustrated in FIG. 2. For the sake of brevity, each of the elements 302, 304, 306, 308, and 310 are not described again.

The detailed projects interface 300 includes a projects window 312 that displays details regarding the one or more projects associated with the user. The one or more projects may be at least one of the document analysis projects and the patent analysis projects. The document analysis projects and patent analysis projects may be collectively referred as “projects” hereafter. The projects window 312 includes an active link 314, an inactive link 316, and an all link 318. The system 100, as illustrated in FIG. 1, provides a list of one or more projects that are currently active and inactive upon receiving an interactive input on the active link 314 and on the inactive link 316, respectively. Further, the system 100 provides a list of all the projects upon receiving an interactive input on the all link 318.

The projects window 312 displays a header row 320 with columns displaying information headings. The columns include information headings such as a project name 322, a code 324 corresponding to the project, a client name 326, a number of patents 328, a project type 330, a name of an owner 332, and a status 334. The projects window 312 also includes a list of projects 336, which are rows under the header row 320, and each row displays information of a single project of the list of projects 336. Each row includes information such as a project name, a code corresponding to the project, a client name, number of patents, a project type, name of an owner, and a status corresponding to the project. The information mentioned above is positioned under the corresponding information headings such as the project name 322, the code 324 corresponding to the project, the client name 326, the number of patents 328, the project type 330, the name of an owner 332, and the status 334, respectively. The information headings such as the project name 322, the code 324, and the client name 326 have a functionality similar to the information headings such as the project name 218, the project code 220, and the client name 222, respectively, as illustrated in FIG. 2. For the sake of brevity, each of the elements 322, 324, and 326 are not described again.

Information under information heading for the number of patents 328 includes a total number of patents that are associated with each project of the list of projects 336. The information under information header for the project type 330 includes a type of work the project is associated with. Further, information under information heading for the name of the owner 332 includes name of a user. For example, the name of the user under the owner information heading 332 may be the user responsible for managing the project. The information under information heading for the status 334 includes the current status of the project, such as active, inactive, and the like. The information displayed under the information headings may be sorted and filtered by interacting with corresponding ellipsis components 342.

In an embodiment, the displayed information of each project in respective rows include hyperlinks to the project data interface 400, later illustrated in FIG. 4. When a selection on the hyperlink of a project is received, the system 100 provides information regarding the selected project in the project data interface 400. A date filter component 338 allows a user to filter the list of projects 336 based on a time period, for example, projects created within seven days.

The detailed projects interface 300 includes a date filter component 338 that is used for filtering the list of projects 336 based on a period or a specific date that may be associated with the start or end of any project of the list of projects 336. The detailed projects interface 300 further includes an add new button 340 for creating or adding a new project. The system 100, in an example, provides an interface (not shown) for receiving details associated with the new project, the details include project name, a project code, a project owner, client information, a type of project, notes associated with the new project, a start date, an end date, and a status indicator. Based on the type or project or the name of owner, the system 100 assigns the newly created project to a user, such as a project manager. Further, one or more users may be manually added to the project(s). The end date may be auto populated based on a time period that is predetermined if a service level agreement (SLA) exists between the client and an organization of the user. The system 100 after receiving a confirmation to create the new project, adds the details of the new project to the list of projects 336.

In an embodiment, each row of the list of projects 336 includes a report button (not shown) that directs the user to the report interface 1700, later illustrated in FIG. 17, upon receiving a click. The report interface 1700 displays downloadable statistics and descriptive information related to the corresponding project of the list of projects 336.

FIG. 4 illustrates the project data interface 400 that displays information associated with the selected project, also referred as the project, from the list of one or more projects 336, as illustrated in FIG. 3. The project data interface 400 is a default interface that is provided upon receiving the project selection from the user. The project data interface 400 includes an interface bar 402 with links and corresponding functionality similar to the interface bar 202. A dashboard link 404, a projects link 406, a patent query link 408, and a username information portion 410 have a functionality similar to the dashboard link 204, the projects link 206, the patent query link 208, and the username information portion 210, respectively, as illustrated in FIG. 2. For the sake of brevity, each of the elements 402, 404, 406, 408, and 410 are not described again.

The project data interface 400 includes a main display area 412, an overview portion 414, a secondary data portion 430, and a primary portion 442. The main display area 412 displays a path through which the project data interface 400 is rendered and displays the name of the selected project. For example, the main display area 412 displays the name of the project as sample project 1. The overview portion 414 displays information that provides an overview or summary of the selected project. The overview portion 414 includes a project name field 416 that displays the name of the project received from the user, a project code field 418 that displays the code of the project, a client name field 420 that displays the name of the client, and a project type field 422 that displays a type of project, for example, a landscape project.

Further, the overview portion 414 includes an active toggle element 424 that is by default set to YES. In an embodiment, for establishing a project as a “placeholder” for patent information, the active toggle element 424 is set to YES. If the project is not to be assigned to an analyst to work on, then the active toggle element 424 is switched to NO. Further, the overview portion 414 includes a start date field 426 that displays a date on which the project has begun or is scheduled to begin, and an end date field 428 that displays a deadline date by which the project has ended or is scheduled to end.

The secondary data portion 430 includes a notes area 432 for displaying any comments provided by the user during the creation of the project or during any phase of the project. A project members portion 434 provides information of members or users associated with the project. The information in the project members portion 434, in an example, includes names of the members and email IDs of the member 436, and roles of the members 438. Further, one or more members may be added to the project by the user by interacting with an add user to project button 440. In an example, after receiving an interactive input to the add user to project button 440, the system 100 as illustrated in FIG. 1, provides a dropdown element (not shown) with details of users for receiving a selection.

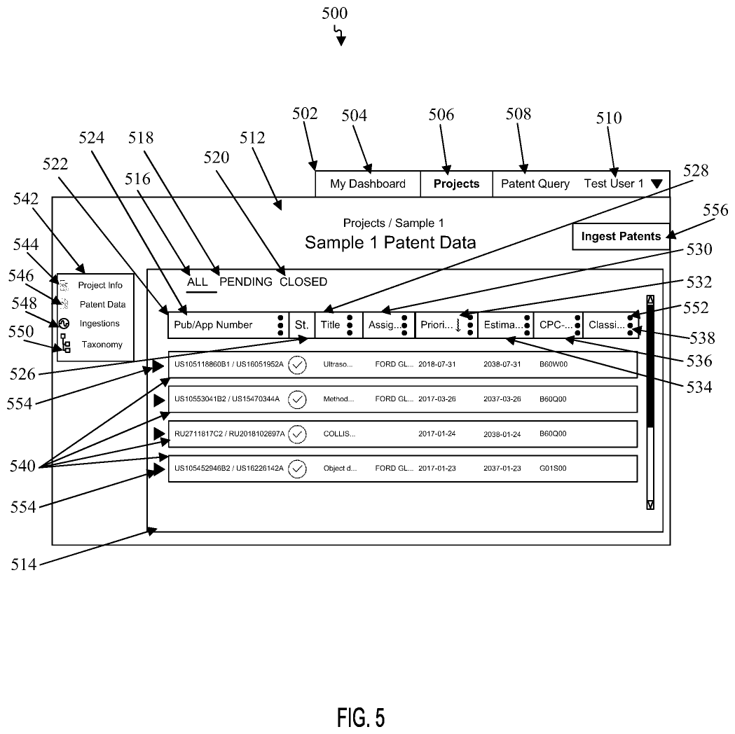

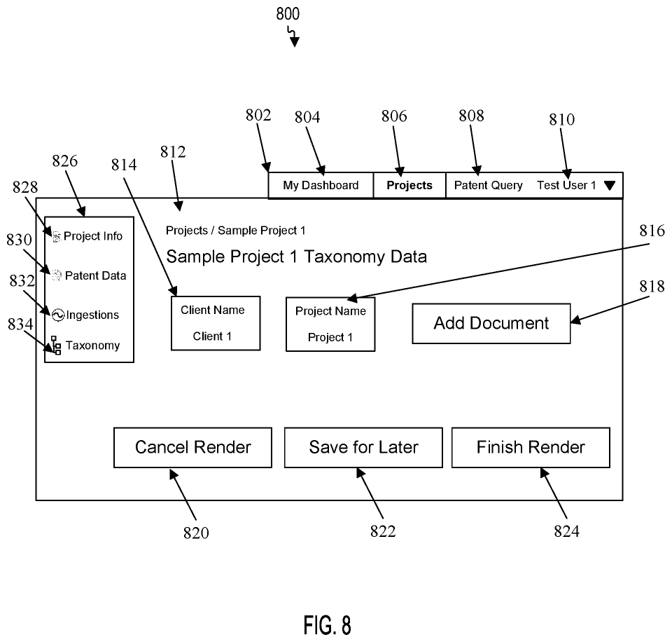

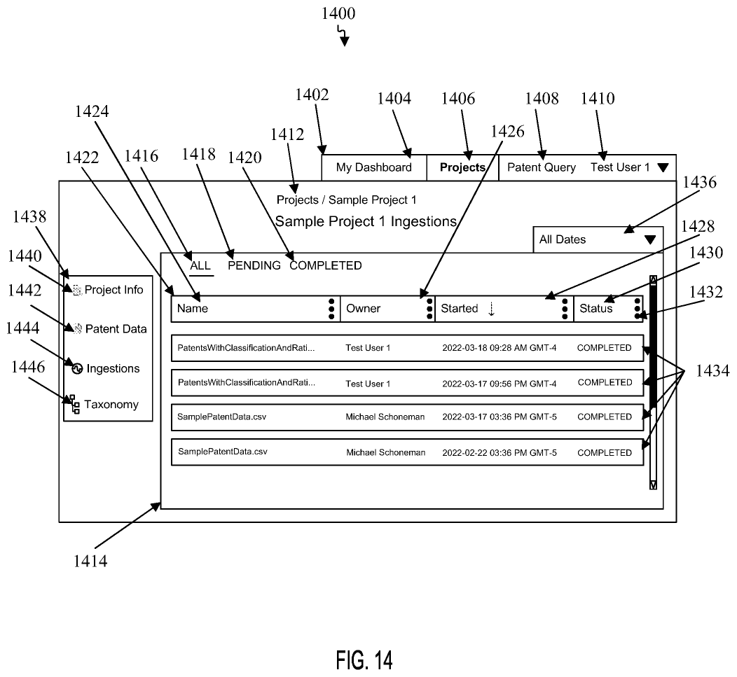

The primary portion 442 includes multiple links corresponding to display different aspects related to the selected project. The primary portion 442 includes a project information link 444, a patent data link 446, an ingestions links 448, and a taxonomy link 450. The system 100 provides the project data interface 400 upon detecting an interaction of the user with the project information link 444 and a patent data interface 500, later illustrated in FIG. 5, upon detecting an interaction of the user with the patent data link 446. After detecting an interaction of the user with the ingestions links 448, the system 100 renders an ingestions information interface 1400, later illustrated in FIG. 14. Further, upon detecting an interaction with the taxonomy link 450, the system 100 renders a taxonomy data import user interface 800, later illustrated in FIG. 8.

FIG. 5 illustrates the patent data interface 500 that displays information related to one or more patents of the project. The patent data interface 500 includes a main display area 512, a first display area 514, and a primary portion 542. The patent data interface 500 includes an interface bar 502 with links and corresponding functionality similar to the interface bar 202. A dashboard link 504, a projects link 506, a patent query link 508, and a username information portion 510 have a functionality similar to the dashboard link 204, the projects link 206, the patent query link 208, and the username information portion 210, respectively, as illustrated in FIG. 2. For the sake of brevity, each of the elements 502, 504, 506, 508, and 510 are not described again.

The main display area 512 includes a path through which the patent data interface 500 has been rendered and the name of the project. Further, the main display area 512 includes an ingest patents button 556 for providing the document upload interface 600, later illustrated in FIG. 6, that allows a user to upload or render a data file with patent-related documents to the system 100, as illustrated in FIG. 1, for analysis. The patent data interface 500 includes a first display area 514 that displays a variety of data corresponding to the patents. The first display area 514 includes a header row 522 with columns displaying information headings. The information headings include a publication or application number 524, a status 526, a title 528, an assignee 530, a priority date 532, an estimated patent expiry date 534, a CPC class 536, and a classification 538.

The first display area 514 also includes a list of patents 540, also referred to as the “patent-related documents,” which are rows under the header row 522, and each row displays information of patent of the list of patents 540. Each row includes information such as a publication or application number, a status, a title, an assignee, a priority date, an estimated patent expiry date, a CPC class, and a classification corresponding to the patent. The information, included in each row, is positioned under the corresponding information headings such as the publication or application number 524, the status 526, the title 528, the assignee 530, the priority date 532, the estimated patent expiry date 534, the CPC class 536, and the classification 538, respectively. The information under the information headings may be sorted and filtered based on one or more preferences of the user by interacting with corresponding ellipsis components 552. In an embodiment, the displayed information of each patent-related document in respective rows includes hyperlinks to the detailed analysis user interface 1100, later illustrated in FIG. 11. When a selection on the hyperlink of a patent-related document, such as a first document, is received, the system 100 provides information regarding the first document in the detailed analysis user interface 1100.

Further, the system 100 may render an expansion area (not shown) with additional details corresponding to a patent in the list of patents 540, upon receiving an interactive input with an expansion element 554 positioned, in an example, beside each row of the list of patents 540. The list of patents 540 may be filtered based on statuses corresponding to each patent of the list of patents 540. For example, the list of patents 540 may be filtered based on patents or patent applications which are yet to be assigned to a user by interacting with a pending link 518, patents or patent applications which are assigned to a user by interacting with a closed link 520, and the complete list of patents 540 by interacting with an all link 516. In an embodiment, the first display area 514 displays the complete list of patents 540, by default.

A primary portion 542 has a functionality similar to the primary portion 442 illustrated in FIG. 4. Also, a project information link 544, a patent data link 546, an ingestions link 548, and a taxonomy link 550 have a functionality similar to the project information link 444, the patent data link 446, the ingestions links 448, and the taxonomy link 450. For the sake of brevity, each of the elements 542, 544, 546, 548, and 550 are not described again.

FIG. 6 illustrates the document upload interface 600, provided by the user interface service 102, as illustrated in FIG. 1, that receives patent or taxonomy related documents for the project, such as the patent analysis project.

The project is defined by a project data structure, the project may be the patent analysis project or the document analysis project. The project data structure defines data classes relating the project and a relationship among the data classes. The data classes include a project name, patent-related documents for the project, a team of analysts and a project lead assigned to the project. The data classes further include a taxonomy of categories and subcategories for use in analyzing the patent-related documents in the project, and keywords assisting in the analysis of the patent-related documents in the project.

The document upload interface 600 is rendered upon receiving a click on the ingest patents button 556, as illustrated in FIG. 5. The user uploads a data file, through the document upload interface 600, which is in a format that is compatible with the system 100, as illustrated in FIG. 1. The document upload interface 600 may receive the data file when the user either drags and drops the data file into an upload area 604 or by browsing files that are located either external or internal to a computing system by clicking on the upload area 604. The data file may include at least one of patent-related information and taxonomy related information and the format or a template for the data file is downloadable by interacting with a hyperlink 602.

In an example, the data file includes the patent-related documents and associated biographical data. The associated biographical data includes information pertaining to the patent-related document such as title, abstract, dates associated with the patent-related documents, for example priority date, classes, and the like. In an embodiment, the data file is a comma-separated values (CSV) file. In another embodiment, the data file is a report from one or more patent-related tools, applications or platforms that may provide patent metadata. In yet another embodiment, the system 100 may automatically receive a report document from one or more patent-related tools, applications or platforms directly after the report document generation.

The document upload interface 600 provides a list of ingestion options 606 that allows the user to specifically indicate to the analysis service 104, as illustrated in FIG. 1, as to how the uploaded data file or document is to be ingested. The list of ingestion options 606 include an ignore unknown columns option 608, an auto create taxonomy option 610, an auto add rating parameters option 612, and an auto close patents option 614 that the user may select or deselect based on user preferences.

When the user selects the ignore unknown columns option 608, the analysis service 104 receives an indication to ignore one or more columns in the data file with unknown names and allow columns with recognized names while ingesting the data file. The analysis service 104 also receives an indication to not to interrupt or abort the ingestion when the analysis service 104 encounters the one or more columns with unknown names. When the user deselects the ignore unknown columns option 608, the analysis service 104 receives an indication to not to ignore and parse through the one or more columns with unknown names. The analysis service 104 also receives an indication to interrupt or abort the ingestion when the analysis service 104 encounters the one or more columns with unknown names. In an embodiment, the user interface service 102 provides a pop-up interface with details corresponding to the one or more columns with unknown names each time the analysis service 104 encounters the one or more columns with unknown names.

When the user selects the auto create taxonomy option 610, the analysis service 104 receives an indication to automatically create a taxonomy from relevant columns, for example a classification column, in the data file. The taxonomy may be defined as a hierarchical structure that is used to classify patents according to role of the respective patents in product functionality. When the user deselects the auto create taxonomy option 610, the analysis service 104 receives an indication to not to automatically create a taxonomy. In an embodiment, the auto create taxonomy option 610 may receive a deselection if the data file does not include relevant columns that may be used to build the taxonomy, if the data file is a taxonomy related document, that is, a taxonomy list, or if the user prefers to build or determine the taxonomy.

When the user selects the auto add rating parameters option 612, the analysis service 104 receives an indication to automatically include or consider a column that comprises ratings corresponding to each line item of the data file. For example, the data file includes a ratings column that specifies ratings for each of the one or more patents, the analysis service 104 receives an indication to consider data of the ratings column. When the user deselects the auto add rating parameters option 612, the analysis service 104 receives an indication to not to automatically consider the ratings column. In an embodiment, the auto add rating parameters option 612 may receive a deselection if the data file does not include a rating column that may be used, if the data file is a taxonomy related document, that is, a taxonomy list, or if the user prefers to provide ratings in real-time.

When the user selects the auto close patents option 614, the analysis service 104 receives an indication to automatically mark one or more patents included as line items in the data file as closed after ingestion. In an embodiment, the data file is ingested for historical/archival purposes, which is stored in at least one of the internal database 106 and the external database 110, and data file does not require any assignment and analysis. When the user deselects the auto close patents option 614, the analysis service 104 receives an indication to not to automatically mark the patents related documents as closed in the data file and not to archive the data file.

The document upload interface 600 includes a start ingestion button 616 and a cancel button 618. The system 100 begins ingesting the uploaded document or the data file upon receiving an interactive input on the start ingestion button 616. The system 100 cancels the ingestion of the data file upon receiving an interactive input on the cancel button 618.

In an embodiment, the document upload interface 600 is configured to receive a legacy data document as the data file, which corresponds to a project that has been executed and has been previously analyzed. The data file includes results of the previous analysis in one or more columns. The analysis results are, in an example, classifications and ratings in corresponding columns for each row line item associated with the one or more patents related documents of the data file. The capability of the document upload interface 600 to receive the legacy data document as the data file allows the user to build up and perform further analysis. The usage of the legacy data document allows the system 100 to leverage the data in the data file for forthcoming analysis or analyzing other data file with one or more patent-related documents.

For example, a data file corresponding to a first project, which is a legacy data document, includes biographical data along with other necessary data associated with multiple patents. One of the multiple patent-related documents, such as patent A, was previously analyzed and is also to be analyzed for a current project, such as a second project. When the legacy data document is uploaded through the document upload interface 600, the analysis service 104 parses through the legacy data document and the data file corresponding to the second project.

The analysis service 104 determines patents that exist or are common in both the legacy data document and the data file corresponding to the second project. Further, the analysis service 104 extracts and utilizes the ratings and classifications assigned to the common patents while analyzing the document related to the first project. This allows the user to have a ready reference to the previous ratings and classifications and supports the user to make an informed decision while rating and classifying the common patents while executing the second project. Also, efforts of the user and time required for analyzing the current project by the user is reduced due to the awareness regarding the previous analysis results and also reduces discrepancies while ranking or classifying the patents in the first project.

After ingesting the data file, for example, with the patent-related information, the analysis service 104 associates the list of patent-related documents and associated biographical data to the project in the project data structure. The analysis service 104 parses the data file to identify data such as category headings, and the biographical data of the patent-related documents. Subsequently, the analysis service 104 maps the identified data to the data classes of the project data structure and maps the data file to the project created. Further, the analysis service 104 provides the parsed and extracted information from the data file to the user interface service 102. Based on the received information, the user interface service 102 populates one or more interfaces such as the detailed projects interface 300, as illustrated in FIG. 3, the patent data interface 500, as illustrated in FIG. 5, and the like. For example, each row of the list of patents 540, illustrated in FIG. 5, includes a patent-related document of the plurality of documents in the ingested data file and corresponding biographical data.

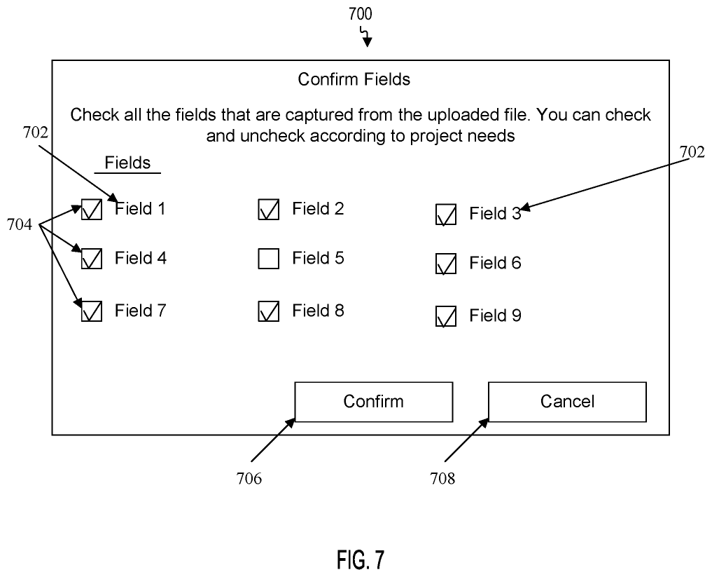

FIG. 7 illustrates a field data interface 700 provided by the user interface service 102, as illustrated in FIG. 1, with a list of fields related to the ingested data file. After the analysis service 104, as illustrated in FIG. 1, ingests and parses the data file, the identified category headings are displayed as fields 702 in the field data interface 700 for reviewing the fields identified. The field data interface 700 includes checkbox elements 704 for each of the displayed fields 702. Upon selection of a checkbox element 704 of the field 702, the analysis service 104 considers the field for further or forthcoming categorization, whereas upon a deselection of the checkbox element 704 of the field 702, the analysis service 104 omits the field for further or forthcoming analysis. A confirm button 706 allows the user to submit the choices corresponding to the fields 702, to the analysis service 104. A cancel button 708 allows the user to cancel the submission of choices corresponding to the fields 702, to the analysis service 104.

FIG. 8 illustrates the taxonomy data import user interface 800 that the user interface service 102, as illustrated in FIG. 1, provides for rendering one or more documents corresponding to taxonomy associated with the project to the system 100. The taxonomy data import user interface 800 includes an interface bar 802 with links and corresponding functionality similar to the interface bar 202. A dashboard link 804, a projects link 806, a patent query link 808, and a username information portion 810 have a functionality similar to the dashboard link 204, the projects link 206, the patent query link 208, and the username information portion 210, respectively, as illustrated in FIG. 2. Further, the taxonomy data mimport user interface 800 includes a main display area 812 that has a functionality similar to the main display area 512, as illustrated in FIG. 5. For the sake of brevity, each of the elements 802, 804, 806, 808, 810 and 812 are not described again.

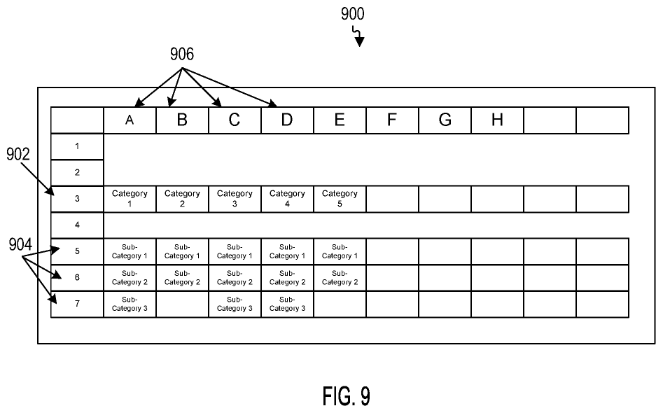

The taxonomy data import user interface 800 displays name of a client associated with the project in a client name block 814 and name of the project in a project name block 816. The user may upload or render a data file including a taxonomy list of the categories and the related subcategories to the system 100 for analysis by clicking on an add document button 818. The taxonomy list, for example, is a taxonomy data file 900, later illustrated in FIG. 9. The process of rendering the data file may be cancelled, saved for later, or completed upon receiving an interactive input to a cancel render button 820, to a save for later button 822, and to a finish render 824, respectively, by the system 100.

A primary portion 826 has a functionality similar to the primary portion 442 illustrated in FIG. 4. Also, a project information link 828, a patent data link 830, an ingestions link 832, and a taxonomy link 834 have a functionality similar to the project information link 444, the patent data link 446, the ingestions links 448, and the taxonomy link 450. For the sake of brevity, each of the elements 826, 828, 830, 832, and 834 are not described again.

FIG. 9 illustrates the taxonomy data file 900 that includes the taxonomy list. The taxonomy list defines a relationship between categories and subcategories. The categories and the subcategories are attributes that are considered for analyzing the one or more patents. The taxonomy data file 900 includes a row of categories 902, with each category in the row 902 placed in individual column 906. Each category has one or more subcategories that are positioned beneath the row of categories 902, in the column 906 corresponding to the category. Each subcategory of a corresponding category is positioned in an individual row 904. In an example, the categories and the subcategories may be modified during the analysis, by the analysis service 104, as illustrated in FIG. 1.

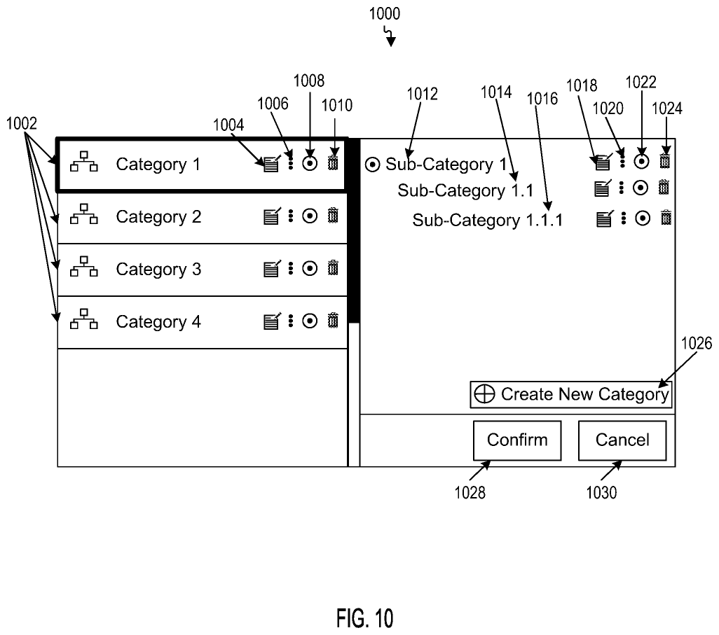

FIG. 10 illustrates a taxonomy modification interface 1000 for receiving modifications to the categories and corresponding subcategories. After receiving the taxonomy data file 900, as illustrated in FIG. 9, through the taxonomy data import user interface 800, as illustrated in FIG. 8, the analysis service 104 parses the taxonomy data file 900. Upon parsing, the analysis service 104 provides, for example, categories 1002 and corresponding subcategories 1012, 1014, and 1016 to the user interface service 102, as illustrated in FIG. 1. The received categories 1002 and the subcategories 1012, 1014, and 1016, that is the taxonomy, are displayed in the taxonomy modification interface 1000 by the user interface service 102. The taxonomy modification interface 1000 may also receive a modification or an edit to the displayed taxonomy.

The modification may be a change in name of one of the categories using a name icon 1004 or a change in name of one of the subcategories using a name icon 1018, or a deletion of one of the categories using a delete icon 1010 or deletion of one of subcategories using a delete icon 1024. The modification may be reordering of the relationship between one or more categories using a reorder icon 1006 or reordering of the relationship between one or more subcategories using a reorder icon 1020.

The categories 1002 may be expanded to display the corresponding subcategories 1012, 1014, and 1016 using an expand icon 1008. Also, the subcategories 1012 may be expanded to display a next level of subcategories 1014 and 1016 subsequent to the subcategories 1012 using an expand icon 1022. A new category is created through the taxonomy modification interface 1000 by using a create new category button 1026. The modifications may be confirmed by interacting with a confirm button 1028 and may be cancelled by interacting with a cancel button 1030.

FIG. 11 illustrates the detailed analysis user interface 1100 that is a consistent user interface for reviewing all patent-related documents of the rendered data file in the patent analysis project. In an embodiment, detailed analysis user interface 1100 may be used for previewing the edited or the unedited taxonomy. The detailed analysis user interface 1100 includes a toolbox 1102 with a keyword interface link 1104, a browsing link 1106, and a download icon 1108.

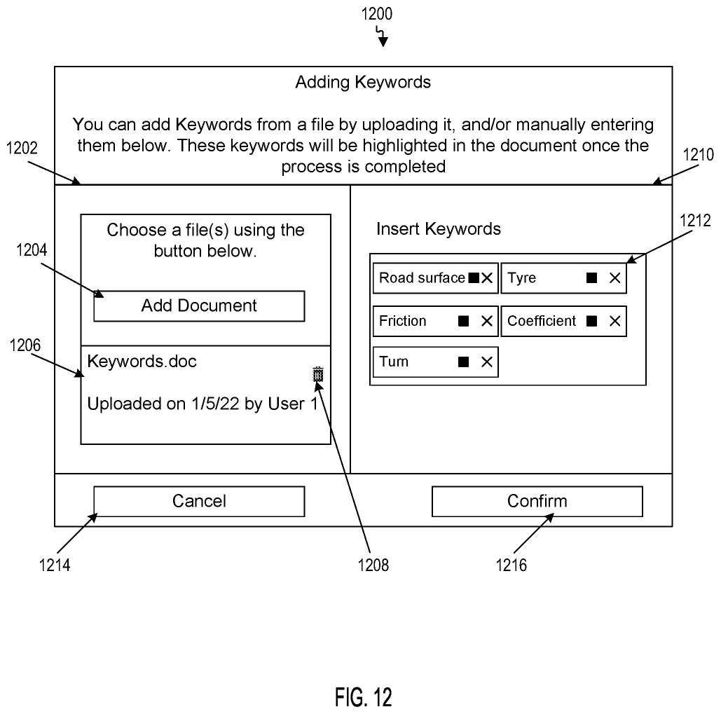

Upon receiving an interactive input to the keyword interface link 1104, the system 100 provides a keyword input interface 1200, as illustrated in FIG. 12, for receiving one or more keywords. Upon receiving an interactive input to the browsing link 1106, the system 100 directs the user to a search engine to view the selected patent-related document online. Further, upon receiving an interactive input to the download icon 1108, the system 100 allows the user to download the information displayed on the detailed analysis user interface 1100. The downloaded information is stored in at least one of the internal database 106 and external database 110, as illustrated in FIG. 1.

The analysis service 104 parses the uploaded data file, as discussed in FIG. 6, including the plurality of documents and associated biographical data, and associates the list of patent-related documents and associated biographical data to the project data structure. The detailed analysis user interface 1100 displays the title 1110 of the selected document of the plurality of documents, such as the first document, as discussed in FIG. 5.

The detailed analysis user interface 1100 includes a first portion 1112 with biographical data 1114 of the document and a navigation component 1120 that allows the user to surf through different documents of the plurality of documents. A flag button 1122 of the first portion 1112 allows the user to mark or flag the patent-related document for requesting other patent analysts or users to review the flagged patent-related document. In an embodiment, the system 100 populates the flagged patents interface with documents that are flagged, as discussed previously in FIG. 2.

The detailed analysis user interface 1100 may be used to display the information imported into the project or configured for the patent analysis project. The analysis service 104 parses the imported information that allows the user to individually review each of the plurality of patent-related documents. A text display region 1126 in the first portion 1112 displays content of specification or text 1128 of the patent-related document after the system 100 receives an interactive input to an analysis button 1116 in the first portion 1112. The text display region 1126 displays the text 1128 of the first document such as an abstract, claims, a detailed description, and the like, associated with the first document. In an embodiment, the text display region 1126 includes links to one or more patent databases. After the system 100 receives an interactive input to a details button 1118, the text display region 1126 displays biographical details, such as estimated expiration date, status, publication date, priority country, priority number, and the like. In an embodiment, the information displayed after receiving an interactive input to the analysis button 1116 and the details button 1118, are same.

Further, the analysis service 104 retrieves the taxonomy of categories and subcategories imported from the taxonomy data file 900 using the document upload interface 600, as illustrated in FIG. 6, or taxonomy data import user interface 800, as illustrated in FIG. 8. The retrieved taxonomy of categories and subcategories are imported into the project in the project data structure. The analysis service 104 parses, populates, and presents the data from the taxonomy in a first interface portion 1130, which includes categories 1132 and subcategories 1134. The first interface portion 1130 may receive a selection of one or more of the categories 1132 or the subcategories 1134 which pertain to the first document using corresponding checkbox components 1136.

The selection of categories 1132 or the subcategories 1134 associates a respective patent-related document, such as the first document, with the selected category 1132 or the subcategories 1134 as an attribute of the patent-related document. The selected categories 1132 or the subcategories 1134 is a classification input that classifies the first document with a first classification. After receiving an input or a click on an apply to family button 1124, the analysis service 104 automatically analyses other documents in the plurality of documents to identify a subset of documents that are similar to the first document. After the analysis and identification of the subset of document, the analysis service 104 automatically classifies the subset of the documents that are similar to the first document with the first classification.

In an embodiment, the detailed analysis user interface 1100 may automatically receive inputs pertaining to a second document of a plurality of documents which is similar to the first document, the input associated with the second document includes the first classification.

The selected categories 1132 or the subcategories 1134 are attributes associated with the first document and the attributes are also referred as values. The values corresponding to the first document are stored in the internal database 106, as illustrated in FIG. 1. In an example, the values are copied from one family member patent-related document to another family member patent-related document thereby avoiding reproduction of the analysis by the analysis service 104. In an embodiment, the detailed analysis user interface 1100 receives a selection of an option to copy the values associated with the selection of the one or more of the categories 1132 or the subcategories 1134, related to the first document. The values are copied to the categories and subcategories associated to the second document, which is identified to be related to the first document.

For the automatic analysis of the other documents of the plurality of documents, the analysis service 104 determines a common family attribute associated with the subset of the documents and the common family attribute corresponds to a common priority application. The determination of the common family attribute includes determining that the subset of documents have a priority application in common. After determining the common family attribute, the analysis service 104 determines a textual similarity between the documents having the common family attribute. Further, the analysis service 104 determines that if a document with the common family attribute has a textual similarity that is not sufficiently similar to the first document, then the document is excluded from the subset of documents that are similar to the first document.

In an embodiment, the automatic analysis of the other documents of the plurality of documents includes applying a machine learning algorithm to the plurality of documents such that the machine learning algorithm identifies the subset of documents that are similar to the first document. The machine learning algorithm, for example, may be one or a combination of: RAKE, Doc2Vec, Part-of-speech tagger, Named-entity recognition, and the like.

In an embodiment, the automatic analysis of the other documents of the plurality of documents includes parsing the plurality of documents with a natural language processing algorithm. The analysis service 104 creates representations of the plurality of documents by using an output of the natural language processing algorithm as an input into a neural network. Further, the created representations are clustered in an embedding space and representations of the plurality of documents that are most proximate to a representation of the first document are the subset of the documents that are similar to the first document. Further, the detailed analysis user interface 1100 receives inputs pertaining to one or more subsequent documents after the first document of the plurality of documents, such as the second document.

In an embodiment, the detailed analysis user interface 1100 may receive a plurality of comments pertaining to one of the categories 1132 and the subcategories 1134, the client, the project, and the like. An analyst of the team of analysts, the project lead, or manager may add one or more comments which may be visible to the team of analysts and the project lead or may be selectively visible to the project lead to provide additional information.

The detailed analysis user interface 1100 includes a ratings area 1138 for receiving inputs related to ratings corresponding to the patent-related document, such as the first document. The ratings area 1138 includes a justification portion 1140, an enforceability input element 1142, a comments input element 1144, and a relevance input element 1146.

The enforceability input element 1142 receives a rating parameter input from the user for determining a value for enforcing the patent-related document. In an embodiment, the enforceability input element 1142 may receive a numeric value, for example, Fibonacci series, for rating the patent-related document, where a lower number input may indicate the patent-related document to be of a lower value and a higher number may indicate the patent-related document to be of a higher value.

In another embodiment, the enforceability input element 1142 may receive a Boolean or binary value, such as Yes and No, for rating the patent-related document, where the Yes input indicates that the patent-related document is valuable to be enforced and a No input indicates that the patent-related document is less or not valuable to be enforced. In yet another embodiment, the enforceability input element 1142 may receive a text input related to the enforceability of the patent-related document, and the analysis service 104 may use the natural language processing process for determining the value of the patent-related document. In yet another embodiment, the enforceability input element 1142 may receive a range or a percentage for determining the value of the patent-related document.

Based on the input to the enforceability input element 1142, the analysis service 104 determines the value of the patent-related document and classifies or categorizes the patent-related document either to be enforceable and non-enforceable or may classify or categorize the patent-related document as low, medium, or high valued.

The justification portion 1140 receives one or more reasons from the user for providing a specific input to the enforceability input element 1142. In an embodiment, the analysis service 104 may consider the one or more reasons along with the input to the enforceability input element 1142 for determining the value of the patent-related document. The comments input element 1144 may receive a descriptive input regarding the patent-related document, a supplementary input related to the one or more reasons in the justification portion 1140, or the like.

The relevance input element 1146 may receive an input if the categories 1132 or subcategories 1134 analyzed and assigned to the patent-related document are relevant or not. If the input to the relevance input element 1146 is provided as not relevant, then the patent-related document is removed from the subset of documents with the determined classification, for example, the first classification. In an embodiment, the detailed analysis user interface 1100 includes an interface element (not shown) for providing an initial relevance interface. The initial relevance user interface includes a link to each patent-related document of the plurality of documents and a relevance selection input. The user interface service 102 would then receive an input in the relevance selection input classifying a subset of the patent-related documents of the corresponding project as relevant or not relevant. Further, the user may filter the patent-related documents in the initial relevance interface by relevance. The filtering of the patent-related documents allows presentation of only the patent-related documents that are marked relevant, in the detailed analysis user interface 1100 or in the relevance selection input.

In an embodiment, if the system 100 receives the legacy data document, then the analysis service 104 parses and extracts relevant previously analyzed data to automatically populate the ratings area 1138 and the first interface portion 1130. The populated first interface portion 1130 and the ratings area 1138 may merely display classification associated with a selected document of the legacy data document. In an embodiment, to modify the classification, that is, the categories 1132 or the subcategories 1134, related to the patent-related document of the legacy data document, the user may be required to modify corresponding data in the legacy data document and upload the modified legacy data document through the document upload interface 600. Upon receiving the modified legacy data document, the analysis service 104 parses and populates the first interface portion 1130 with the modified categories and subcategories.

The classification and ratings are shown in different interface portions of the detailed analysis user interface 1100, such as the first interface portion 1130 and the ratings area 1138, respectively. However, the present disclosure is not limited to one particular way of displaying/presenting information but corresponding functionality of the first interface portion 1130 and the ratings area 1138 may be provided on any portion of the detailed analysis user interface 1100 without any limitation.

FIG. 12 illustrates the keyword input interface 1200, provided by the user interface service 102, as illustrated in FIG. 1, for receiving one or more keyword inputs. The keywords are terms that may be used within a document to define a process, a component, alphanumeric characters, and the like. The keyword input interface 1200 includes a document input portion 1202 which receives a keyword document with the one or more keywords that correspond with the analysis project. The keyword input interface 1200 receives the keyword document after detecting an interaction of the user with an add document button 1204. A document details portion 1206 displays details such as identifier (ID) of the user who uploaded the keyword document, and date along with time stamps associated with the uploaded keyword document. The document details portion 1206 also includes a delete icon 1208 for deleting the uploaded keyword document. In an embodiment, the legacy data document includes keywords associated to the one or more patent-related documents listed. The legacy data document with the keywords may be uploaded by the user using the keyword input interface 1200 by interacting with the add document button 1204.

The keyword input interface 1200 is also capable of receiving manually entered keyword inputs through a manual input portion 1210. The manual input portion 1210 may receive keywords 1212 from the user and automatically assign a unique color to each received keyword. In an embodiment, the keyword input interface 1200 includes a color selector icon (not shown) that provides a color palette for selecting a color for a keyword that is manually entered or a keyword in the keyword document.

The process of rendering or uploading the keyword document or entering keywords may be cancelled or confirmed after detecting an interaction with a cancel button 1214 and a confirm button 1216, respectively.

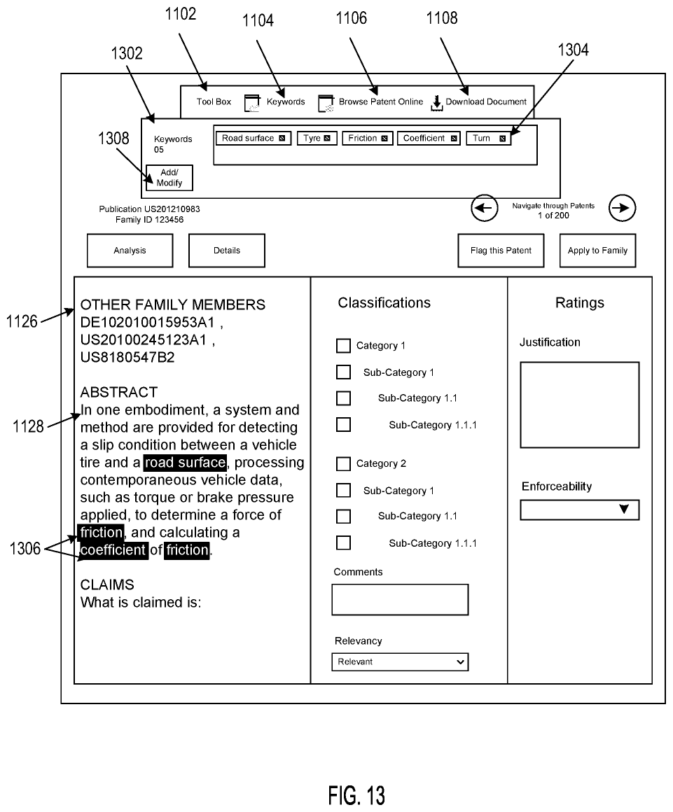

FIG. 13 illustrates the detailed analysis user interface 1100 with a second interface portion 1302 that displays one or more keywords 1304 that are to be identified in the patent-related document displayed in the text display region 1126. The keywords 1304 in the second interface portion 1302 may be same as the keywords 1212 or the keywords in the uploaded keyword document or the legacy data document, as disclosed in FIG. 12. The second interface portion 1302, in an embodiment, may also include unique color codes for each of the one or more keywords 1304. The second interface portion 1302 includes an add/modify button 1308 that receives an interactive input from the user for modifying the keywords. Upon receiving the interactive input on the add/modify button 1308, the system 100 directs the user to the keyword input interface 1200, as illustrated in FIG. 12.

The addition or modification of the one or more keywords is received, for example, through the keyword input interface 1200. The internal database 106 is configured to save the keywords in the project data structure and are presented to one or more users such as the team of analysts and a project lead, a manager assigned to the project, and the like. The analysis service 104 compares the text 1128 of the patent-related document with the received keywords 1304 to detect the presence of one or more keywords 1306 in the text 1128 of the patent-related document. Upon detecting the presence of a keyword, the analysis service 104 highlights the keyword 1306 in the contents of the specification displayed in the text display region 1126 with the corresponding color assigned to the keyword 1304. In an embodiment, the received one or more keywords, may be tallied with the subcategories 1012, 1014, and 1016 where the analysis service 104, as illustrated in FIG. 1, determines the existence of a relevant relationship between the subcategories and the received one or more keywords.

The highlighting of the keywords 1306 with the different colors on the text display region 1126 and the presenting the keywords 1304 with corresponding assigned colors allows the user to identify the keywords 1304 without a requirement to read the text 1128 of the patent-related document completely. In an embodiment, the user interface service 102 allows the user to assign or modify colors associated with the keywords 1304. The analysis service 104, upon receiving the added or modified keywords, assigns a color for each of the added or modified keywords and parses the patent-related documents to identify the added or modified keywords along with previously present keywords. For example, a keyword 1304, such as friction, in the second interface portion 1302 has been associated with a color, such as green. The analysis service 104 compares the text 1128 of the first document in the text display region 1126, as illustrated in FIG. 11, and upon identifying the keyword, the analysis service 104 highlights the keyword 1306 identified, with the corresponding green color.

FIG. 14 illustrates the ingestions information interface 1400 that displays information related to one or more ingestion documents associated with the project. The ingestion documents may be the data file with the patent-related documents or the taxonomy data file. The ingestions information interface 1400 includes an interface bar 1402 with links and corresponding functionality similar to the interface bar 202. A dashboard link 1404, a projects link 1406, a patent query link 1408, and a username information portion 1410 have a functionality similar to the dashboard link 204, the projects link 206, the patent query link 208, and the username information portion 210, respectively, as illustrated in FIG. 2. For the sake of brevity, each of the elements 1402, 1404, 1406, 1408, and 1410 are not described again.

Further, the ingestions information interface 1400 includes a main display area 1412 that includes a path through which the ingestions information interface 1400 has been rendered and name of the associated project.

The ingestions information interface 1400 includes a first display area 1414 that displays information corresponding to the ingestion documents. The first display area 1414 includes a header row 1422 with columns displaying information headings. The columns include information headings such as a name of a document 1424, an owner name 1426, a start date and time 1428, also referred as a timestamp 1428, and a status 1430.

The first display area 1414 includes a list of ingestion documents 1434, which are rows under the header row 1422, and each row displays information of a single ingestion document of the list of ingestion documents 1434. Each row includes information such as a name of a document, an owner name, a timestamp, and a status positioned under the corresponding information headings such as the name of a document 1424, the owner name 1426, the timestamp 1428, and the status 1430, respectively.

The information displayed under the owner name information heading 1426 of each row of the list of ingestion documents 1434 is a hyperlink. The system 100, after detecting a selection of a hyperlink under the owner name information heading 1426, provides the ingestion report interface 1500, later illustrated in FIG. 15, with information corresponding to the ingestion document. The information under the information headings may be sorted and filtered based on one or more preferences of the user by interacting with corresponding ellipsis components 1432. The status information under information heading for the status 1430 is similar to the status information under information heading for the status 236, as illustrated in FIG. 2. For the sake of brevity, the status information under the information heading for the status 1430 is not described again.

The list of ingestion documents 1434 may be filtered based on statuses corresponding to each ingestion document. For example, the list of ingestion documents 1434 may be filtered for displaying the ingestion documents with pending status when the system 100, as illustrated in FIG. 1, receives an interactive input to a pending link 1418.

Further, the list of ingestion documents 1434 with completed status, may be filtered and displayed when the system 100 receives an interactive input to a completed link 1420. The system 100 displays the complete list of ingestion documents 1434 by default and after detecting an interaction with an all link 1416. A date filter component 1436 allows a user to filter the list of ingestion documents 1434 based on a time period, for example, ingestion documents uploaded within last seven days.

A primary portion 1438 of the ingestions information interface 1400 has a functionality similar to the primary portion 442 illustrated in FIG. 4. Also, a project information link 1440, a patent data link 1442, an ingestions link 1444, and a taxonomy link 1446 have a functionality similar to the project information link 444, the patent data link 446, the ingestions links 448, and the taxonomy link 450. For the sake of brevity, each of the elements 1438, 1440, 1442, 1444, and 1446 are not described again.

FIG. 15 illustrates the ingestion report interface 1500 that displays information corresponding to the selected ingestion document from the list of ingestion documents 1434, as illustrated in FIG. 14. The ingestion report interface 1500 includes an interface bar 1502 with links and corresponding functionality similar to the interface bar 202. A dashboard link 1504, a projects link 1506, a patent query link 1508, and a username information portion 1510 have a functionality similar to the dashboard link 204, the projects link 206, the patent query link 208, and the username information portion 210, respectively, as illustrated in FIG. 2. For the sake of brevity, each of the elements 1502, 1504, 1506, 1508, and 1510 are not described again.

The ingestion report interface 1500 includes a main display area 1512, a first report area 1514, and a second report area 1516. The main display area 1512 comprises a path through which the ingestion report interface 1500 has been rendered, and the name of the selected ingestion document with the corresponding timestamp information, for example, date and time associated with uploading the document.

The first report area 1514 includes specific information associated with the selected ingestion document. In an example, the first report area 1514 includes information of a number of patents submitted, a number of new patents, a number of updated patents, and a number of errors associated with the selected ingestion document, which is the data file. In an example, the number of patents submitted discloses a count of patent-related documents in the ingestion document associated with the project. The number of new patents discloses a count of the ingested patent-related documents that are new to the system 100, as disclosed in FIG. 1, or have been ingested by the system 100 for a first time. In an embodiment, the system 100 ingests and stores complete data related to the new patents or patent-related documents. The number of updated patents discloses a count of the previously ingested patent-related documents with new patent specific data. In an embodiment, the system 100 stores data identified as patent related data or patent specific data, once per patent-related document. The system 100, after receiving new patent specific data, overwrites the new patent specific data on existing patent specific data corresponding to the patent-related document. In an embodiment, if the system 100 identifies data as project related data, the system 100 stores the project related data per project and associates it with the patent-related document. The project related data may be different depending on a context of the project. The number of errors discloses a count of the errors or issues due to which the ingestion document was not ingested properly. The status of the ingestion may be warning, failed, and the like, as disclosed in FIG. 2.

The second report area 1516 includes descriptive information related to the ingestion of the selected ingestion document, for example, notification information of starting and ending the ingestion, time of ending the ingestion, and the like. For example, the status of the ingestion, which is information heading for the status 1430 as illustrated in FIG. 14 or the information heading for the status 236 illustrated in FIG. 2, is a warning. The first report area 1514 displays that the total number of patents ingested is three, the new patents ingested is zero, and the number of errors is three. The second report area 1516 provides notification of starting the ingestion, the list of ingestion options 606, as illustrated in FIG. 6, selected or deselected, description of the three errors, notification of ending the ingestion, time of ending the ingestion, and the like.

A primary portion 1518 has a functionality similar to the primary portion 442 illustrated in FIG. 4. Also, a project information link 1520, a patent data link 1522, an ingestions link 1524, and a taxonomy link 1526 have a functionality similar to the project information link 444, the patent data link 446, the ingestions links 448, and the taxonomy link 450. For the sake of brevity, each of the elements 1518, 1520, 1522, 1524 and 1526 are not described again.

FIG. 16 illustrates the patent query interface 1600 provided by the user interface service 102, as illustrated in FIG. 1, after detecting an interaction with the patent query link 208, as illustrated in FIG. 2. The patent query interface 1600 includes an interface bar 1602 with links and corresponding functionality similar to the interface bar 202. A dashboard link 1604, a projects link 1606, a patent query link 1608, and a username information portion 1610 have a functionality similar to the dashboard link 204, the projects link 206, the patent query link 208, and the username information portion 210, respectively, as illustrated in FIG. 2. For the sake of brevity, each of the elements 1602, 1604, 1606, 1608, and 1610 are not described again.

The patent query interface 1600 includes a main portion 1612 with a query input portion 1614 and a first area 1616. The query input portion 1614 receives one or more patent queries. Each patent query of the one or more patent queries comprises biographical data corresponding to a patent or a patent application. The biographical data, in an example, includes a patent number, a patent application number, or a combination of the patent and publication numbers. The analysis service 104, determines one or more projects that are associated with each of the one or more patent queries. The user interface service 102 displays a response to each of the one or more patent queries in the first area 1616, the response includes information corresponding to the determined one or more projects that are associated with each of the one or more patent queries.

The first area 1616 includes a header row 1618 with columns displaying information headings. The columns include information headings such as a name of a project 1620, an owner name 1622, and a status 1624. The first area 1616 displays biographical data and a list of projects 1632 for each patent query of the one or more patent queries. The list of projects 1632 includes a row associated to each project. Each row includes information such as a name of a document, an owner name, and a status under the information headings such as information heading for the name of the project 1620, information heading for the owner name 1622, and information heading for the status 1624, respectively. The information displayed under information heading for the name of the project 1620 of each row of the list of projects 1632 is a hyperlink. The system 100, after receiving an interactive input to the hyperlink of a project, provides the detailed analysis user interface 1100 with the information corresponding to the project, as illustrated and discussed in FIG. 11.

The information under the information headings may be sorted and filtered based on one or more preferences of the user by interacting with corresponding ellipsis components 1626. The system 100 may render an expansion area (not shown) with additional details corresponding to a patent, in the list of projects 1632, upon detecting an interaction with an expansion element 1630 positioned, in an example, beside each row of the list of projects 1632. The system 100 resets the patent query interface 1600 by erasing the one or more patent queries in the query input portion 1614 and corresponding information in the first area 1616, after receiving an interactive input to a reset button 1644. In an embodiment, the response of the system 100 in the first area 1616 along with the patent queries in the patent query interface 1600 may be downloaded.

A primary portion 1634 has a functionality similar to the primary portion 442 illustrated in FIG. 4. Also, a project information link 1636, a patent data link 1638, an ingestions link 1640, and a taxonomy link 1642 have a functionality similar to the project information link 444, the patent data link 446, the ingestions links 448, and the taxonomy link 450, respectively. For the sake of brevity, each of the elements 1634, 1636, 1638, 1640, and 1642 are not described again.

FIG. 17 illustrates the report interface 1700 provided by the report generation service 108, as illustrated in FIG. 1, for report building and displaying visualizations. The system 100, as illustrated in FIG. 1, provides the analysis such as the classifications, the rating, and the like, from the analysis service 104 to the report generation service 108. The report generation service 108 collates the received analysis based on the classification for displaying visualizations and also allows the user to build the reports. The report interface 1700 includes a project information area 1702 that includes information related to the project. In an example, the project information area 1702 includes details related to a name of a client and a project, a deadline date, a count of comments, patents canvased, patent families, associated industries, and countries canvased.

The report interface 1700 includes a visualization area 1706 for displaying the visualizations based on at least the identified categories. In an example, the visualization area 1706 may include graphs related to patent filing trends across one or more countries with respect to the identified categories. In an example, the visualization area 1706 may include graphs representing licensing avenues for the patents or the patent applications related to the identified categories, inventors of the patents or the patent applications related to the identified categories, patent renewals based on current relevancy of the identified categories, and the like.

The system 100 allows the user to choose different details for customizing the project information area 1702 and the visualization area 1706 after receiving an interactive input to a settings icon 1704. The details in the project information area 1702 and the visualization area 1706 may be downloaded by using a download button 1708.

In an embodiment, the system 100 provides a graphical report corresponding to the analysis of the uploaded data file including the list of patent-related documents. The graphical report, in an example, includes a hierarchy representation of Cooperative Patent Classification (CPC) related to the patent-related documents. The hierarchy representation of CPC includes a primary CPC followed by one or more levels of secondary CPCs that are sub-classes of the primary CPC. The system 100 allows the user to navigate through one or more levels of the hierarchy representation of the CPC. Upon detecting an interaction, such as hovering, on the graphical representation of the primary CPC or one or more levels of the secondary CPCs, the system 100 displays a corresponding CPC definition. The graphical representation may initially display the primary CPC and allow the user to zoom in for navigating through the one or more levels of the secondary CPC or the graphical representation may display the primary CPC and corresponding one or more secondary CPCs in a single view. The graphical representation thus provides a comprehensive view of the CPCs of all the patent-related documents and reduces a necessity to read through each of the patent-related documents to determine the primary CPC and the secondary CPCs.

The graphical report, in an example, displays biographical data of each patent-related document of the uploaded data file, as discussed in FIG. 6. The system 100 allows the 1user to choose or filter one or more types of biographical data that shall be populated in the graphical report, such as title, abstract, inventor names, and the like. The graphical report is also configured to receive keywords and configured to allow the user to search the keywords in the presented biographical data. The keywords may also be searched in the user specified biographical data. The system 100, upon finding the keywords in the biographical data, highlights each of keywords with unique colors. The system 100 may also receive comments associated with each of the patent-related documents. The graphical report, therefore, provides a comprehensive view of the biographical information of all the patent-related documents and reduces a necessity to open and read each patent-related document for determining relevancy.

In an example, the graphical report includes graphs that are plotted against different information that are selected based on a necessity or application for which the graphs may be used. The graphical report includes various interface components for receiving inputs regarding different information, such as checkboxes or drop-down elements to select all or one or more industries, assignees, statuses, countries, application year, expiry year, and the like, associated with the patent-related documents in the data file of the project. expiry year, and the like, associated with the patent-related documents in the data file of the project. The graphical report may include graphs that are plotted to determine assignees and a count of associated patent-related documents in the data file of the project. The graphical report may include graphs to determine industries and a count of the associated patent-related documents in the data file of the project. The graphical report may include graphs to determine patent filing trends of the assignees with respect to various industries corresponding to the patent-related documents in the data file of the project.

The position and/or placement of different elements of the interfaces disclosed in FIGS. 2 through 17 are depicted for exemplary purpose and other variations and/or combinations of such elements may be realized without any limitation. It should be understood that there can be additional, fewer, or alternative elements performing respective functionalities either sequentially or parallelly in various embodiments disclosed herein.

FIG. 18 illustrates an example method 1800 for automatically categorizing a document in the document analysis project. Although the example method 1800 depicts a particular sequence of operations, the sequence may be altered without departing from the scope of the present disclosure. For example, some of the operations depicted may be performed in parallel or in a different sequence that does not materially affect the function of the method 1800. In other examples, different components of an example device or system that implements the method 1800 may perform functions at substantially the same time or in a specific sequence.

According to some examples, the user interface service 102, as illustrated in FIG. 1, presents a graphical user interface for receiving inputs pertaining to a first document of a plurality of documents in the document analysis project at block 1805. The plurality of documents are patent-related documents, which include one or more granted patents, published patent applications, and unpublished patent applications.

The graphical user interface, rendered by the user interface service 102 as illustrated in FIG. 1, receives a classification input classifying the first document with the first classification at block 1810. The analysis service 104, as illustrated in FIG. 1, automatically analyzes other documents from the plurality of documents, apart from the first document, in the internal database 106, as illustrated in FIG. 1, to identify a subset of documents that are similar to the first document at block 1815. In some embodiments, the automatic analysis at block 1815 may be performed prior to the receipt of the classification input at block 1810.

In some embodiments, the automatic analysis of the other documents at block 1815, by the analysis service 104, may include determining the common family attribute associated with the subset of the documents. In an embodiment, the determination of the common family attribute includes selecting the subset of documents with a common priority application.

Further, the analysis service 104 determines a textual similarity between the documents, which have the common family attribute. However, upon determining that the textual similarity of at least one document is not sufficiently similar to the first document, the determined textually dissimilar document is excluded from the subset of documents that are similar to the first document. In an example, the textual analysis includes a comparison of a primary document with a secondary document to determine a percentage of change in the secondary document relative to the primary document.

In some embodiments, the automatic analysis of the other documents at block 1815 comprises applying a machine learning algorithm to the plurality of documents. The machine learning algorithm identifies the subset of documents that are similar to the first document. The machine learning algorithm may include supervised learning, unsupervised learning, or reinforcement learning.

In some embodiments, the automatic analysis of the other documents at block 1815 may include parsing the plurality of documents with a natural language processing algorithm.

Further, an output from block 1815 is provided as an input to the neural network. The neural network, upon receiving the inputs, creates and provides representations as an output. The created representations are used for determining the subset of the documents that are similar to the first document, as discussed in FIG. 1.

The analysis service 104 further automatically classifies the identified subset of the documents that are similar to the first document with the first classification at block 1820.

A graphical user interface that receives inputs pertaining to a second document from the plurality of documents in the document analysis project is presented at block 1825. For example, the user interface service 102, as illustrated in FIG. 1, may present a graphical user interface to receive inputs pertaining to the second document of a plurality of documents in the document analysis project. When the second document is among the subset of documents that are similar to the first document, the graphical user interface may be pre-populated with the first classification from the first document. The graphical user interface may further receive additional classifications.

FIGS. 19A-19B illustrate an example method 1900 for conducting a patent analysis project by an analysis team. In an embodiment, the analysis team may include a team of analysts and a project lead or manager. In some embodiments, the analysis team may include only a team of analysts. Although the example method 1900 depicts a particular sequence of operations, the sequence may be altered without departing from the scope of the present disclosure. For example, some of the operations depicted may be performed in parallel or in a different sequence that does not materially affect the function of method 1900. In other examples, different components of an example device or system that implements the method 1900 may perform functions at substantially the same time or in a specific sequence.

According to some examples, the document analysis system 100, as illustrated in FIG. 1 may be configured to manage the patent analysis project. The document analysis system 100 includes a series of user interfaces provided by user interface service 102, as illustrated in FIG. 1, to define a project, a team, patent-related documents to be analyzed, criteria against which the patent-related documents are to be analyzed, and interfaces for facilitating the display of such analysis at block 1902.

According to some examples, the present disclosure includes providing project data structure, stored in the internal database 106, as illustrated in FIG. 1. The internal database 106 may include data classes related to a project and a relationship among the data classes at block 1904. The data classes include a project name and the patent-related documents for the project, such as the patent analysis project. The data classes further include the team of analysts and the project lead or manager assigned to the project, a taxonomy of categories and subcategories for use in analyzing the patent-related documents in the project, and keywords assisting in the analysis of the patent-related documents in the project. The keywords are terms that may be used within a document to define a process, a component, alphanumeric characters, and the like.

According to some examples, the user interface service 102 presents a patent documents data import user interface, such as the document upload interface 600, as illustrated in FIG. 6, at block 1906. The patent documents data import user interface, provided by the user interface service 102, receives a data file including a list of patent-related documents and associated biographical data at block 1908 and stores the data file in the internal database 106. The associated biographical data includes information pertaining to the patent-related document such as title, abstract, dates associated with the patent-related documents, for example, priority date, classes, and the like.

The analysis service 104, as illustrated in FIG. 1, parses the data file, including the list of patent-related documents and associated biographical data, to identify category headings, and the biographical data corresponding to each of the patent-related documents at block 1910.

The analysis service 104 associates the list of patent-related documents and associated biographical data to the project in the project data structure, upon parsing the patent-related documents to identify data such as category headings, and the biographical data, at block 1912. The analysis service 104 maps the identified data to the data classes of the project data structure. The parsed and identified category headings are displayed as the fields 702 in a user interface, such as the field data interface 700 for a review, as illustrated in FIG. 7.

The user interface service 102 presents a user interface for receiving a data file, which is the taxonomy data file 900, as illustrated in FIG. 9, that includes a taxonomy list of the categories and the related subcategories, at block 1914. The user interface may be the taxonomy data import user interface 800, as illustrated in FIG. 8, and the document upload interface 600, as illustrated in FIG. 6. The taxonomy further defines a relationship between the categories and the subcategories. The categories and the subcategories are defining attributes against which the plurality of documents may be analyzed. The analysis service 104 receives the data file, which is the taxonomy data file 900 that includes the taxonomy of the categories and the related subcategories, at block 1916. The data file including the taxonomy of categories, in an example, may be modified during the analysis of the data file by the analysis service 104.

Upon receiving the taxonomy list using the taxonomy data import user interface 800 or the document upload interface 600, the user interface service 102 provides the taxonomy modification interface 1000, as illustrated in FIG. 10, to receive a modification or an edit to the taxonomy. The edit includes the addition of one of the categories and the subcategories, a change in name of one of the categories and the subcategories, and the like, at block 1918. In an embodiment, the document analysis system 100 allows the edited or the unedited taxonomy to be previewed on the detailed analysis user interface 1100.

Further, the analysis service 104 parses the data file, which is the taxonomy data file 900 with the taxonomy list and associates the taxonomy to the project in the project data structure at block 1920, similar to block 1912. In an embodiment, the user interface service 102 presents the initial relevance user interface, as discussed in FIG. 11, which may include links to the patent-related documents and the relevance selection input for each patent-related document, at block 1922. The user interface service 102 would then receive an input in the relevance selection input classifying a subset of the patent-related documents in the patent analysis project as relevant at block 1924. The input may be a selection from a drop-down list that lists options, such as relevant and not relevant, for each of the patent-related documents listed in the initial relevance user interface.

The user interface service 102 presents the detailed analysis user interface 1100 as illustrated in FIG. 11, at block 1926, that includes the text 1128 of the first document to be analyzed as part of the project.

The detailed analysis user interface 1100 may be used to display all the information imported into the project or configured for the patent analysis project. The detailed analysis user interface 1100 allows the user to review all patent-related documents in the project. For example, all the patent-related documents imported using the document upload interface 600 may be individually reviewed in the text display region 1126.

The taxonomy of categories and the subcategories are retrieved from the taxonomy data file 900 and imported into the project. Upon retrieving the taxonomy of categories and subcategories, the analysis service 104 parses and populates the detailed analysis user interface 1100 with the retrieved taxonomy of categories 1132 and the subcategories 1134 in the first interface portion 1130.

According to some examples, the detailed analysis user interface 1100 may receive a selection of one or more of the categories or the subcategories which pertain to the first document through the interface rendered by the user interface service 102, at block 1928. The categories 1132 or the subcategories 1134 may be selected by the user to associate a respective patent-related document, such as the first document, with the selected category 1132 or subcategories 1134 as an attribute of the patent-related document. Alternatively, as addressed above, the categories 1132 or the subcategories 1134 may be automatically selected by analysis service 104 when the patent-related document is similar to a previously reviewed patent-related document. In an embodiment, the selection of the categories 1132 or subcategories 1134 may allow the document analysis system 100 to filter the patent-related documents based on the selected categories 1132 or the subcategories 1134. The analysis service 104, upon filtering, provides the patent-related documents that correspond to the selected categories 1132 or the subcategories only. In an embodiment, the document analysis system 100 may include artificial intelligence algorithms to categorize the patent-related documents or validate the received selection of categories or subcategories corresponding to the patent-related documents based on the frequency of keywords, or combination of keywords, and the like.

The analysis service 104 stores values associated with the selection of the one or more of the categories 1132 or the subcategories 1134, which pertain to the first document at block 1930. For example, the internal database 106 may store values associated with the selection of the one or more of the categories 1132 or subcategories 1134, which pertain to the first document. The values are attributes, for example, the one or more categories that are selected. In an example, the values are copied from one family member patent-related document to another family member patent-related document thereby avoiding reproduction of the analysis by the analysis service 104.

Further, the detailed analysis user interface 1100, provided by the user interface service 102, receives a selection of an option to copy the values associated with the selection of the one or more categories 1132 or the subcategories 1134, which pertain to the first document to the second document that is related to the first document, at block 1932.

According to some examples, in response to the selection, the present technology may automatically store the values in association with the second document at block 1934. For example, the analysis service 104 may, in response to the selection, automatically store the values in association with the second document, in the internal database 106.

The detailed analysis user interface 1100 illustrated in FIG. 13 may include one or more highlighted keywords 1306 presented in the second interface portion 1302, that occur in the text 1128 of the first document. The addition or modification of the one or more keywords is received, for example, through the keyword input interface 1200, as illustrated in FIG. 12.

The second interface portion 1302 in the detailed analysis user interface 1100 provides an area to display the received keywords along with a different color assigned to each of the keywords 1304. According to some examples of the present disclosure, the detailed analysis user interface 1100, illustrated in FIG. 13, receives a user command within the second interface portion 1302 of the detailed analysis user interface 1100 to add or modify one or more of the keywords, at block 1936. The analysis service 104, upon receiving the added or modified keywords, assigns a color for each of the added or modified keywords and parses the patent-related documents to identify the added or modified keywords along with previously present keywords. The internal database 106 is configured to save the keywords 1304 in the project data structure. The saved keywords 1304 are presented to the team of analysts and a project lead or manager assigned to the project at block 1938.

The detailed analysis user interface 1100 may receive a one or more comments pertaining to one of the categories 1132 and the subcategories 1134, client, project, and the like, in the comments input element 1144, as illustrated in FIG. 11, at block 1940. An analyst of the team of analysts or the project lead or manager may add one or more comments to provide additional information, to indicate a requirement to modify any aspect corresponding to one or more categories 1132 or subcategories 1134. The indication may highlight an issue corresponding to one or more categories 1132 or subcategories 1134. The added comments may be visible to the team of analysts and the project lead or may be selectively visible to the project lead.

The internal database 106 stores the received comments as part of the project data structure, whereby the team of analysts and the project lead assigned to the project may view the plurality of comments at block 1942. In an embodiment, a continuous thread or an overall stream of comments may be displayed. In an example, the plurality of comments may be linked to at least the category, the client, the project, and the like, such that the comments may be abstracted out or filtered based on the category, the client, the project, and the like.

In some embodiments, edits to add or remove a category, subcategory, keyword, project notes, or to add patent-related documents to the patent analysis project may be received by the system 100. The edits received may cause detailed analysis user interface 1100 to update for all team members so all analysts are working off the same interface. In some embodiments, in response to an edit, the present technology may create a workflow task to review already reviewed patent-related documents in view of changed keywords, categories, or subcategories. In some embodiments, a natural language processing tool may first analyze such documents to present a list of documents that include a phrase with a semantic meaning associated with an edited or added a category to be reviewed in light of the changed criteria.

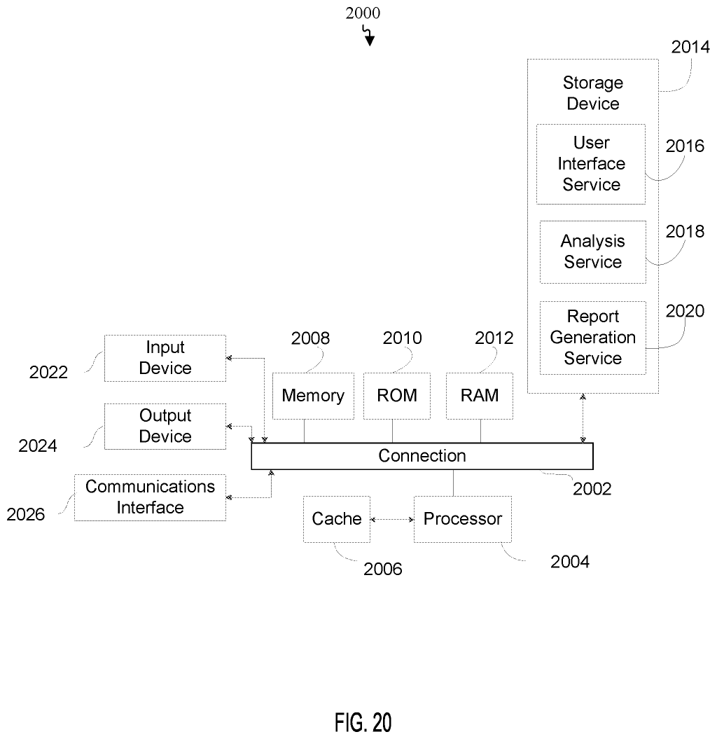

FIG. 20 shows an example of computing system 2000, which may be for example any computing device making up document analysis system 100, or any component thereof in which the components of the system are in communication with each other using connection 2002. The connection 2002 may be a physical connection via a bus, or a direct connection into processor 2004, such as in a chipset architecture, or the connection 2002 may also be a virtual connection, networked connection, or logical connection.

In some embodiments, the computing system 2000 is a distributed system in which the functions described in this disclosure may be distributed within a datacenter, multiple data centers, a peer network, and the like. In some embodiments, one or more of the described system components represents many such components each performing some or all of the function for which the component is described. In some embodiments, the components may be physical or virtual devices.

The example computing system 2000 includes at least one processing unit (CPU or processor) 2004, and the connection 2002 couples various system components including system memory 2008, such as read-only memory (ROM) 2010 and random-access memory (RAM) 2012, to the processor 2004. The computing system 2000 may include a cache of high-speed memory 2006 connected directly with, in close proximity to, or integrated as part of the processor 2004.

The processor 2004 may include any general-purpose processor and a hardware service or software service, such as services 2016, 2018, and 2020 stored in a storage device 2014, configured to control the processor 2004 as well as a special-purpose processor where software instructions are incorporated into the actual processor design. The processor 2004 may essentially be a completely self-contained computing system, containing multiple cores or processors, a bus, memory controller, cache, and the like. A multi-core processor may be symmetric or asymmetric.

To enable user interaction, the computing system 2000 includes an input device 2022, which may represent any number of input mechanisms, such as a microphone for speech, a touch-sensitive screen for gesture or graphical input, keyboard, mouse, motion input, speech, and the like. The computing system 2000 may also include an output device 2024, which may be one or more of a number of output mechanisms known to those of skill in the art. In some instances, multimodal systems may enable a user to provide multiple types of input/output to communicate with the computing system 2000. The computing system 2000 may include communications interface 2026, which may generally govern and manage the user input and system output. There is no restriction on operating on any particular hardware arrangement, and therefore the basic features here may easily be substituted for improved hardware or firmware arrangements as they are developed.

The storage device 2014 may be a non-volatile memory device and may be a hard disk or other types of computer readable media which may store data that are accessible by a computer, such as magnetic cassettes, flash memory cards, solid state memory devices, digital versatile disks, cartridges, random access memories (RAMs), read-only memory (ROM), and/or some combination of these devices.

The storage device 2014 may include software services, servers, services, and the like, that when the code that defines such software is executed by the processor 2004, it causes the system to perform a function. In some embodiments, a hardware service that performs a particular function may include the software component stored in a computer-readable medium in connection with the necessary hardware components, such as the processor 2004, the connection 2002, the output device 2024, and the like, to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service may be software that resides in memory of a client device and/or one or more servers of a content management system and perform one or more functions when a processor executes the software associated with the service. In some embodiments, a service is a program or a collection of programs that carry out a specific function. In some embodiments, a service may be considered a server. The memory may be a non-transitory computer-readable medium.

In some embodiments, the computer-readable storage devices, mediums, and memories may include a cable or wireless signal containing a bit stream and the like. However, when mentioned, non-transitory computer-readable storage media expressly exclude media such as energy, carrier signals, electromagnetic waves, and signals per se.

The non-transitory computer readable storage medium may refer to all computer readable media, for example, non-volatile media, volatile media, and transmission media, except for a transitory, propagating signal. The non-volatile media comprise, for example, solid state drives, optical discs or magnetic disks, and other persistent memory volatile media including a dynamic random-access memory (DRAM), which typically constitute a main memory. The volatile media comprise, for example, a register memory, a processor cache, a random-access memory (RAM), and the like.

Methods according to the above-described examples may be implemented using computer-executable instructions that are stored or otherwise available from computer-readable media. Such instructions may comprise, for example, instructions and data which cause or otherwise configure a general-purpose computer, special purpose computer, or special purpose processing device to perform a certain function or group of functions. Portions of computer resources used may be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, Universal Serial Bus (USB) devices provided with non-volatile memory, networked storage devices, and so on.

Devices implementing methods according to these disclosures may comprise hardware, firmware and/or software, and may take any of a variety of form factors. Typical examples of such form factors include servers, laptops, smartphones, small form factor personal computers, personal digital assistants, and so on. The functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are means for providing the functions described in these disclosures.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a local area network (LAN) and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. For example, the various components can be located in a switch such as a private branch exchange (PBX) and media server, gateway, in one or more communications devices, at one or more users' premises, or some combination thereof. Similarly, one or more functional portions of the system could be distributed between a telecommunications device(s) and an associated computing device.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. Hence, the present disclosure and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

Also, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for automatically categorizing a document in a document analysis project, the method comprising:
presenting a graphical user interface for receiving inputs pertaining to a first document of a plurality of documents in the document analysis project;
receiving, by the graphical user interface, a classification input classifying the first document with a first classification;
automatically analyzing other documents in the plurality of documents to identify a subset of documents that are similar to the first document; and
automatically classifying the subset of the documents that are similar to the first document with the first classification.

2. The method of claim 1, wherein the automatically analyzing the other documents in the plurality of documents comprises:
determining a common family attribute associated with the subset of the documents.

3. The method of claim 2, wherein the plurality of documents are patent-related documents, wherein the common family attribute includes a priority application, and wherein the determining the common family attribute includes determining that the subset of documents that all have the priority application in common.

4. The method of claim 3, wherein after determining the common family attribute, the method comprises:
determining a textual similarity between the documents having the common family attribute; and
determining that at least one document having the common family attribute should be excluded from the subset of documents that are similar to the first document when the textual similarity of the at least one document is not sufficiently similar to the first document.

5. The method of claim 1, wherein the automatically analyzing the other documents in the plurality of documents comprises:
applying a machine learning algorithm to the plurality of documents, wherein the machine learning algorithm identifies the subset of documents that are similar to the first document.

6. The method of claim 1, wherein the automatically analyzing the other documents in the plurality of documents comprises:
parsing the plurality of documents with a natural language processing algorithm;
creating representations of the plurality of documents by inputting an output of the natural language processing algorithm into a neural network which outputs the representations; and
clustering the representations in an embedding space, wherein representations of the documents that are most proximate to a representation of the first document are the subset of the documents that are similar to the first document.

7. The method of claim 1, further comprising:
presenting a graphical user interface for receiving inputs pertaining to a second document of a plurality of documents in a document analysis project, wherein the second document is among the subset of documents that are similar to the first document, the graphical user interface for receiving the inputs pertaining to the second document automatically including the first classification.

8. A method for conducting a patent analysis project by a team of analysts, the method comprising:
presenting a detailed analysis user interface that is a consistent user interface for reviewing all patent-related documents in the patent analysis project, the detailed analysis user interface including:
text of a first patent-related document to be analyzed as part of the patent analysis project, and
categories and related subcategories presented in a first interface portion of the detailed analysis user interface.

9. The method of claim 8, wherein the patent analysis project is defined by a project data structure defining data classes relating to a project and a relationship among the data classes, the data classes include a project name, the patent-related documents for the patent analysis project, a team of analysts and a project lead assigned to the project, a taxonomy of categories and subcategories for use in analyzing the patent-related documents in the project, and keywords assisting in the analysis of the patent-related documents in the project.

10. The method of claim 9, further comprising:
retrieving the taxonomy of categories and subcategories; and
populating the user interface with data from the taxonomy, wherein the categories and subcategories presented in the first interface portion are populated from the taxonomy.

11. The method of claim 9, further comprising:
prior to presenting the detailed analysis user interface, presenting a patent documents data import user interface;
receiving a data file including a list of patent-related documents and associated biographical data within the patent documents data import user interface;
parsing the data file including the list of patent-related documents and associated biographical data to identify category headings, and the biographical data identifying the patent-related documents; and
associating the list of patent-related documents and associated biographical data to the project in the project data structure.

12. The method of claim 9, further comprising:
prior to presenting the detailed analysis user interface, presenting a taxonomy data import user interface;
receiving a data file including the taxonomy of the categories and the related subcategories, wherein the taxonomy further defines a relationship between the categories and the subcategories, the categories and the subcategories defining attributes against which the patent-related documents are being analyzed; and
associating the taxonomy to the project in the project data structure.

13. The method of claim 12, further comprising:
after receiving the data file including the taxonomy, presenting the taxonomy in a user interface; and
receiving an edit to the taxonomy, the edit including an addition of one of the categories or subcategories, a change in name of one of the categories or subcategories, a deletion of one of the categories or subcategories, or a reordering of the relationship between one or more categories and subcategories.

14. The method of claim 9, further comprising:
receiving a comment pertaining to one of the categories or the subcategories; and
storing the comment as part of the project data structure, whereby the team of analysts and a project lead assigned to the project are able to view the comment.

15. The method of claim 8, further comprising:
receiving a selection of one or more of the categories or subcategories which pertain to the first patent-related document; and
storing values associated with the selection of the one or more of the categories or subcategories which pertain to the first patent-related document.

16. The method of claim 15, further comprising:
receiving a selection of an option to copy values associated with the selection of the one or more of the categories or subcategories which pertain to the first patent-related document to a second patent-related document that is related to the first patent-related document; and
in response to the selection, automatically storing the values in association with the second patent-related document.

17. The method of claim 8, further comprising:
prior to presenting the detailed analysis user interface, presenting an initial relevance user interface, the initial relevance user interface including a link to the respective patent-related document of the patent-related documents and a corresponding relevance selection input;
receiving an input in the relevance selection input classifying a subset of the patent-related documents in the patent analysis project as relevant; and
when presenting the detailed analysis user interface, filtering the patent-related documents in the patent analysis project by relevance to only present the patent-related documents marked relevant in the detailed analysis user interface.

18. The method of claim 9, wherein the detailed analysis user interface presents the keywords in a second interface portion, and wherein the method further comprises:
highlighting a keyword presented in the second interface portion where the keyword occurs in a text of the first patent-related document.

19. The method of claim 18, further comprising:
receiving a user command within the second interface portion of the user interface to add or modify one of the keywords; and
after receiving an addition or modification to one of the keywords, saving the keywords in the project data structure, whereby the saved keywords are presented to the team of analysts and a project lead assigned to the project.

20. A system for automatically categorizing a document in an analysis project, the system comprising:
a user interface service configured to present a graphical user interface to receive inputs pertaining to a first document of a plurality of documents in the analysis project; and
an analysis service, the analysis service configured to:
receive a classification input classifying the first document with a first classification through the graphical user interface,
automatically analyze other documents in the plurality of documents to identify a subset of documents that are similar to the first document, and
automatically classify the subset of the documents that are similar to the first document with the first classification.
